(19) United States
(12) Patent Application Publication
(10) Pub. No.: US 2014/0315303 A1
(43) Pub. Date: Oct. 23, 2014

(54) METHOD AND DEVICE FOR SAMPLE PROCESSING

(71) Applicant: CYTOVER INC., Chestnut Hill, MA (US)

(72) Inventor: Lotien R. Huang, Chestnut Hill, MA (US)

(21) Appl. No.: 14/363,260

(22) PCT Filed: Dec. 6, 2012
(86) PCT No.: PCT/US12/68233

§ 371 Date: Jun. 5, 2014

Related U.S. Application Data
(60) Provisional application No. 61/567,920, filed on Dec. 7, 2011.

(51) Int. Cl. G01N 1/31

(52) U.S. Cl. CPC G01N 1/31
USPC 435/366; 435/309.1

(57) ABSTRACT

In accordance with an aspect of the present disclosure there is provided an apparatus for the processing of biological sample. The apparatus comprises a first sheet of material, a second sheet of material bonded to the first sheet of material, and a plurality of chambers defined between the first sheet of material and the second sheet of material, the plurality of chambers including a sample dissociation chamber including an inlet and an outlet; a waste collection chamber including an inlet in fluid communication with the outlet of the sample dissociation chamber, and a cell refinement chamber including an inlet in fluid communication with the sample dissociation chamber and an outlet.

### BACKGROUND

Many techniques in biology and medicine, such as cell separation, flow cytometry, cell assays, and cell therapies are dependent on dissociating tissues to isolate individual cells. Processing tissue samples often involves multiple acts, such as mincing, washing, enzymatic digestion, dissociation, incubation, mixing, clump and debris removal, and concentration. In research laboratories, these acts are often done manually with the sample transferred from test tubes to test tubes in an open environment. Such manual processes require highly trained personnel and the manipulation of biological samples poses potential risks of contamination and infection.

Recently there has been interest in the research and medical communities to isolate cells from adipose tissues. Several techniques have been developed to safely remove portions of adipose tissues from a patient or an animal. For example, tumescent liposuction and water jet liposuction techniques have been widely used to remove fat tissue from patients. Adipose tissues contain adipose cells that store fat and other non-fat cells that maintain the tissues. The constituent cells of adipose tissues, their roles and their interactions are not completely understood, and are a subject of active academic and clinical research.

To study adipose tissues, it may be desirable to dissociate the tissue and isolate the constituent cells. The process may involve releasing the constituent cells, removing debris and unwanted cells, concentrating and enriching cells of interest, and washing the cells. Such process may be laborious and may require highly trained operators, expensive equipment setup, and a laboratory with proper biosafety measures. The multiple manipulation acts may also cause significant loss of cells of interest, making the isolation of rare and low prevalence cells difficult and unreliable. Furthermore, when human samples are used, the risks of cross-contamination and infection may be substantial.

It is therefore desirable to have a method for effective isolation of cells of interest from a tissue, and to have a device that makes isolation of cells from tissues easy and safe.

Bags comprising flexible plastic sheets are widely used to collect, process, and store biological tissue samples, such as peripheral blood, umbilical cord blood, blood components, plasma, bone marrow, lipoaspirates, etc. Bags have the advantage of being flexible and expandable, and are capable of changing their inner volumes to accommodate samples of different volumes. To facilitate sample processing, many individual bags are often fluidicly connected using external tubing to form a system. Such bag and tubing system have been widely used in sample processing, for example, blood fractionation, cell isolation, etc. However, as more processing acts are integrated, the bag and tubing systems quickly become cumbersome, hard to use, and difficult to manufacture. The systems become spaghetti-like and become prone to entanglement, with many components dangling off of each other. To use such devices, an operator needs a high level of training and a long period of hands-on time to set up the complicated devices. The operator also needs to pay extra attention to mount the various parts at the right places in the right order. Furthermore, these devices and systems may be difficult and costly to manufacture as multiple bags, components and tubing stretches often have to be made individually and then assembled. The assembling of such devices may be labor intensive, and may present risks of leakage and contamination, i.e., system failure. For clinical applications, the devices are often single use, and their reliability is important. The intensive labor and device failure risk is a major hurdle for these conventional spaghetti-like systems.

### SUMMARY

In accordance with an aspect of the present disclosure there is provided an apparatus for the processing of biological sample. The apparatus comprises a first sheet of material, a second sheet of material bonded to the first sheet of material, and a plurality of chambers defined between the first sheet of material and the second sheet of material, the plurality of chambers including a sample dissociation chamber including an inlet and an outlet; a waste collection chamber including an inlet in fluid communication with the outlet of the sample dissociation chamber, and a cell refinement chamber including an inlet in fluid communication with the sample dissociation chamber and an outlet.

In accordance with some embodiments the sample dissociation chamber further comprises a mesh filter.

In accordance with some embodiments the mesh filter comprises pores having a pore size of between 20 micrometers and 50 micrometers.

In accordance with some embodiments the apparatus further comprises a mesh filter included in the cell refinement chamber.

In accordance with some embodiments the sample dissociation chamber further comprises a first mesh filter comprising pores having a first pore size, and wherein the cell refinement chamber further comprises a second mesh filter comprising pores having a second pore size.

In accordance with some embodiments the second pore size is smaller than the first pore size.

In accordance with some embodiments the apparatus further comprises a means to control fluid connection between the sample dissociation chamber, the waste collection chamber and the cell refinement chamber.

In accordance with some embodiments the means to control fluid connection comprises a stopcock.

In accordance with some embodiments the apparatus further comprises a flow control device configured to introduce at least one of a rinsing solution and a dissociation solution into the sample dissociation chamber and having an outlet in fluid communication with the tissue dissociation chamber.

In accordance with some embodiments the apparatus further comprises means for applying pressure to one of the sample disassociation chamber and the cell refinement chamber. The means may be disposed between the first sheet of material and the second sheet of material. The means may be disposed about the first sheet of material and/or the second sheet of material.

In accordance with some embodiments the apparatus further comprises a downstream processing apparatus in fluid communication with the outlet of the cell refinement chamber and including at least one microfluidic device configured to separate a fluid output from the cell refinement chamber into a first solution having a first concentration of one or more cells of interest and a second solution having a concentration of the one or more cells of interest which is less than that of the first solution.

In accordance with an aspect of the present disclosure there is provided an apparatus for the processing of biological tissue. The apparatus comprises a first sheet of material, a second sheet of material bonded to the first sheet of material and a plurality of chambers defined between the first sheet of material and the second sheet of material, the plurality of chambers including a tissue dissociation chamber including an inlet, a first outlet, a second outlet, and first mesh filter, a waste collection chamber including an inlet in fluid communication with the first outlet of the tissue dissociation chamber, and one of a cell refinement chamber and a sample collection chamber including an inlet in fluid communication with the second outlet of the tissue dissociation chamber.

In accordance with some embodiments the apparatus further comprises a measuring chamber including an outlet in fluid communication with the inlet of the tissue dissociation chamber.

In accordance with some embodiments each of the tissue dissociation chamber, the waste collection chamber, the cell refinement chamber, and the measuring chamber are defined between the first sheet of material and the second sheet of material.

In accordance with some embodiments the apparatus further comprises a clump reduction chamber in fluid communication between the tissue dissociation chamber and the one of the cell refinement chamber and the sample collection chamber.

In accordance with some embodiments each of the tissue dissociation chamber, the waste collection chamber, the cell refinement chamber, and the clump reduction chamber are defined between the first sheet of material and the second sheet of material.

In accordance with some embodiments the apparatus further comprises a second mesh filter included in the tissue dissociation chamber downstream of the first mesh filter.

In accordance with some embodiments the apparatus further comprises a mesh filter included in the one of the cell refinement chamber and the sample collection chamber.

In accordance with some embodiments the apparatus further comprises a flow control device configured to introduce one of a rinsing solution and a dissociation solution into the tissue dissociation chamber and having an outlet in fluid communication with the tissue dissociation chamber.

In accordance with some embodiments the apparatus further comprises means for applying pressure to one of the tissue disassociation chamber and the one of the cell refinement chamber and the sample collection chamber.

In accordance with some embodiments the apparatus further comprises a downstream processing apparatus in fluid communication with an outlet of the one of the cell refinement chamber and the sample collection chamber and including a microfluidic device configured to separate a fluid output from the one of the cell refinement chamber and the sample collection chamber into a first solution having a first concentration of one or more cells of interest and a second solution having a concentration of the one or more cells of interest which is less than that of the first solution.

In accordance with an aspect of the present disclosure there is provided a sterile and substantially isolated tissue processing system. The system comprises a tissue processing chamber including an inlet, an outlet, and at least one mesh filter disposed between the inlet of the tissue processing chamber and the outlet of the tissue processing chamber, a waste collection chamber included in a same enclosure as the tissue processing chamber, the waste collection chamber including an inlet in fluid communication with the outlet of the tissue processing chamber, and one of a debris removal chamber including a debris removal mechanism, and a sample collection chamber included in the same enclosure as the tissue processing chamber and in fluid communication with the second outlet of the tissue processing chamber.

In accordance with an aspect of the present disclosure there is provided substantially isolated tissue processing system. The system comprises a tissue processing chamber including an inlet, a first outlet, a second outlet, and at least one mesh filter disposed between the inlet of the tissue processing chamber and the first outlet of the tissue processing chamber, a waste collection chamber included in a same enclosure as the tissue processing chamber, the waste collection chamber including an inlet in fluid communication with the first outlet of the tissue processing chamber, and one of a debris removal chamber including a debris removal mechanism, and a sample collection chamber included in the same enclosure as the tissue processing chamber and in fluid communication with the second outlet of the tissue processing chamber.

In accordance with some embodiments the system further comprises a fluid volume measuring chamber in the same enclosure as the tissue processing chamber and including an inlet and an outlet in fluid communication with the inlet of the tissue processing chamber.

In accordance with some embodiments the inlet of the fluid volume measuring chamber and the outlet of the fluid volume measuring chamber each include check valves.

In accordance with some embodiments the first outlet and the second outlet comprise outlets of a stopcock in fluid communication with the tissue processing chamber.

In accordance with an aspect of the present disclosure there is provided a method of processing a tissue sample in a tissue processing system. The method comprises introducing a fluid including a tissue sample to be processed into a fluid volume measuring chamber through an inlet port of the fluid volume measuring chamber, transferring a pre-determined volume of the fluid from the fluid volume measuring chamber to a tissue processing chamber through an outlet port of the fluid volume measuring chamber and an inlet port of the tissue processing chamber, treating the tissue sample in the tissue processing chamber and releasing a sample of cells from the tissue processing chamber through a second outlet of the tissue processing chamber an into a sample storage chamber included in a same enclosure as the tissue processing chamber through an inlet of the sample storage chamber.

In accordance with some embodiments the method further comprises closing the inlet port of the fluid volume measuring chamber and opening the outlet port of the fluid volume measuring chamber subsequent to introducing the fluid including a tissue sample to be processed into the fluid volume measuring chamber and prior to transferring the pre-determined volume of the fluid from the fluid volume measuring chamber to the tissue processing chamber.

In accordance with some embodiments the method further comprises retaining a sample of cells within the tissue processing chamber and transferring a waste fluid through a mesh filter included in the tissue processing chamber and a first outlet of the tissue processing chamber into a waste collection chamber included in the same enclosure as the tissue processing chamber through an inlet of the waste collection chamber.

In accordance with some embodiments the method further comprises extracting the sample of cells from the tissue processing system.

In accordance with some embodiments treating the tissue sample in the tissue processing chamber comprises introducing a tissue cleaning solution into the tissue processing chamber.

In accordance with some embodiments treating the tissue sample in the tissue processing chamber further comprises introducing a tissue dissociating solution into the tissue processing chamber.

In accordance with an aspect of the present disclosure there is provided a method of processing a sample in a tissue processing system. The method comprises introducing a sample to be processed into a tissue processing chamber through an inlet port of the tissue processing chamber, treating the sample in the tissue processing chamber, and releasing cells from the tissue processing chamber through an outlet of the tissue processing chamber into a sample storage chamber included in a same enclosure as the tissue processing chamber through an inlet of the sample storage chamber.

In accordance with some embodiments the method further comprises extracting the sample of cells from the tissue processing system.

In accordance with some embodiments the method further comprises processing the extracted sample of cells in a downstream processing apparatus in fluid communication with an outlet of the sample storage chamber and including at least one microfluidic device configured to separate the extracted sample of cells into a first solution having a first concentration of one or more cells of interest and a second solution having a concentration of the one or more cells of interest which is less than that of the first solution.

In accordance with an aspect of the present disclosure there is provided a method of processing a sample in a tissue processing system. The method comprises introducing a sample to be processed into a tissue processing chamber through an inlet port of the tissue processing chamber, treating the sample in the tissue processing chamber, and transferring cells from the tissue processing chamber through an outlet of the tissue processing chamber into a sample storage chamber included in a same enclosure as the tissue processing chamber through an inlet of the sample storage chamber.

In accordance with some embodiments treating the sample comprises dissociating the sample.

In accordance with some embodiments treating the sample comprises removing excess fluids from the sample.

In accordance with some embodiments treating the sample comprises washing the sample using a rinsing solution.

In accordance with some embodiments treating the sample comprises washing the sample using a rinsing solution and dissociating the sample using a dissociation solution comprising at least one enzyme.

In accordance with some embodiments the method further comprises the removal of debris using a mesh filter included in the sample storage chamber.

In accordance with some embodiments the mesh filter has a pore size of between 15 micrometers and 50 micrometers.

In accordance with some embodiments the method further comprises retaining a sample of cells within the tissue processing chamber and transferring a waste fluid through a mesh filter included in the tissue processing chamber and a first outlet of the tissue processing chamber into a waste collection chamber included in the same enclosure as the tissue processing chamber through an inlet of the waste collection chamber.

In accordance with some embodiments the method further comprises enriching the cells for a target cell population using a microfluidic device.

In accordance with some embodiments the method further comprises extracting the cells from the tissue processing system.

In accordance with some embodiments the method further comprises processing cells in a downstream processing apparatus in fluid communication with an outlet of the sample storage chamber and including at least one microfluidic device configured to separate the cells into a first solution having a first concentration of one or more cells of interest and a second solution having a concentration of the one or more cells of interest which is less than that of the first solution.

In accordance with some embodiments treating the tissue sample in the tissue processing chamber comprises introducing a tissue cleaning solution into the tissue processing chamber.

In accordance with some embodiments treating the tissue sample in the tissue processing chamber further comprises introducing a tissue dissociating solution into the tissue processing chamber.

In accordance with some embodiments the cells extracted are adipose derived stem cells.

In accordance with some embodiments the cells extracted are mesenchymal stem cells.

In accordance with some embodiments the cells extracted are stem cells.

In accordance with some embodiments the cells extracted are pancreatic islet cells.

In accordance with some embodiments the cells extracted are bacteria.

In accordance with some embodiments the cells extracted are stromal vascular fraction cells.

In accordance with some embodiments the cells extracted are stem cells derived from an umbilical cord.

In accordance with some embodiments the cells extracted are yeasts.

In accordance with some embodiments the cells extracted are parasites.

In accordance with some embodiments the cells extracted are a foodborne pathogen.

In accordance with an aspect of the present disclosure there is provided a substantially isolated tissue processing system. The system comprises a fluid volume measuring chamber including an inlet and an outlet, a tissue processing chamber included in a same enclosure as the fluid volume measuring chamber, the tissue processing chamber including an inlet in fluid communication with the outlet of the fluid volume measuring chamber, a first outlet, a second outlet, and at least one mesh filter disposed between the inlet of the tissue processing chamber and the first outlet of the tissue processing chamber, a waste collection chamber included in the same enclosure as the fluid volume measuring chamber and tissue processing chamber, the waste collection chamber including an inlet in fluid communication with the first outlet of the tissue processing chamber, and one of a debris removal chamber including a debris removal mechanism, and a sample collection chamber included in the same enclosure as the fluid volume measuring chamber and tissue processing chamber and in fluid communication with the second outlet of the tissue processing chamber.

In accordance with some embodiments the inlet of the fluid volume measuring chamber and the outlet of the fluid volume measuring chamber each include check valves.

In accordance with an aspect of the present disclosure there is provided a substantially isolated tissue processing system. The system comprises a sample washing and dissociation chamber, including three inlet ports, a first outlet port and a second outlet port, and a mesh disposed between the three inlet ports and the first and second outlet ports, a clump reduction chamber comprising an inlet connector in fluid connection with the first outlet port of the sample washing and dissociation chamber, an outlet, and a mesh disposed between the inlet connector and the outlet, a reservoir for isolated cells and further debris removal having an inlet in fluid communication with the outlet of the clump reduction chamber, and a waste solution collection chamber, having an inlet in fluid communication with the second outlet port of the sample washing and dissociation chamber.

In accordance with some embodiments each of the sample washing and dissociation chamber, the clump reduction chamber, the reservoir, and the waste solution collection chamber included in a same sealed packaging.

In accordance with an aspect of the present disclosure there is provided a method of processing a tissue sample in a tissue processing system. The method comprises introducing a fluid including a tissue sample to be processed into a fluid volume measuring chamber through an inlet port of the fluid volume measuring chamber while an outlet port of the fluid volume measuring chamber is closed, closing the inlet port of the fluid volume measuring chamber, opening the outlet port of the fluid volume measuring chamber, transferring a pre-determined volume of the fluid from the fluid volume measuring chamber to a tissue processing chamber located within a same enclosure as the fluid volume measuring chamber through the outlet port of the fluid volume measuring chamber and an inlet port of the tissue processing chamber, treating the tissue sample in the tissue processing chamber, and releasing the sample of cells from the tissue processing chamber through a second outlet of the tissue processing chamber an into a sample storage chamber included in the same enclosure as the fluid volume measuring chamber and tissue processing chamber through an inlet of the sample storage chamber.

In some embodiments the method further comprises retaining a sample of cells within the tissue processing chamber and transferring a waste fluid through a mesh filter included in the tissue processing chamber and a first outlet of the tissue processing chamber into a waste collection chamber included in the same enclosure as the fluid volume measuring chamber and tissue processing chamber through an inlet of the waste collection chamber.

In some embodiments the method further comprises extracting the sample of cells from the tissue processing system.

In accordance with an aspect of the present disclosure there is provided a method of processing a tissue sample in a tissue processing system. The method comprises introducing a tissue sample processing solution into a fluid volume measuring chamber through an inlet port of the fluid volume measuring chamber while an outlet port of the fluid volume measuring chamber is closed, closing the inlet port of the fluid volume measuring chamber, opening the outlet port of the fluid volume measuring chamber, transferring a pre-determined volume of the solution from the fluid volume measuring chamber to a tissue processing chamber located within a same enclosure as the fluid volume measuring chamber through the outlet port of the fluid volume measuring chamber and a first inlet port of the tissue processing chamber, introducing a tissue sample to be treated into the tissue processing chamber through a second inlet port of the tissue processing chamber, treating the tissue sample in the tissue processing chamber, releasing the sample of cells from the tissue processing chamber through a second outlet of the tissue processing chamber an into a debris removal chamber included in the same enclosure as the fluid volume measuring chamber and tissue processing chamber through an inlet of the debris removal chamber, and removing undesired cells from the sample of cells in the debris removal chamber to form a purified cell sample.

In some embodiments the method further comprises retaining a sample of cells within the tissue processing chamber and transferring a waste fluid through a mesh filter included in the tissue processing chamber and a first outlet of the tissue processing chamber into a waste collection chamber included in the same enclosure and the fluid volume measuring chamber and tissue processing chamber through an inlet of the waste collection chamber.

In some embodiments the method further comprises extracting the purified cell sample from the tissue processing system.

In accordance with an aspect of the present disclosure there is provided an apparatus for isolation of non-fat cells from an adipose tissue sample. The apparatus comprises a first sheet of material, a second sheet of material bonded to the first sheet of material, and a plurality of chambers defined between the first sheet of material and the second sheet of material, the plurality of chambers including a sample dissociation chamber including an inlet and an outlet, a waste collection chamber including an inlet in fluid communication with the outlet of the sample dissociation chamber, and a cell refinement chamber including an inlet in fluid communication with the sample dissociation chamber and an outlet.

In accordance with some embodiments the sample dissociation chamber further comprises a mesh filter comprising pores having a pore size of between 70 μm and 300 μm.

In accordance with some embodiments the apparatus further comprises a mesh filter included in the cell refinement chamber comprising pores having a pore size of between 20 μm and 50 μm.

In accordance with some embodiments the sample dissociation chamber further comprises a first mesh filter comprising pores having a first pore size, and wherein the cell refinement chamber further comprises a second mesh filter comprising pores having a second pore size, wherein the second pore size is smaller than the first pore size.

In accordance with some embodiments the apparatus further comprises a means to control fluid connection between the sample dissociation chamber, the waste collection chamber and the cell refinement chamber.

In accordance with some embodiments the means to control fluid connection comprises a stopcock.

In accordance with some embodiments the apparatus further comprises a flow control device configured to introduce at least one of a rinsing solution and a dissociation solution into the sample dissociation chamber and having an outlet in fluid communication with the sample dissociation chamber.

In accordance with some embodiments the apparatus further comprises means for applying pressure to one of the sample disassociation chamber and the cell refinement chamber.

In accordance with some embodiments the apparatus further comprises a downstream processing apparatus in fluid communication with the outlet of the cell refinement chamber and including at least one microfluidic device configured to separate a fluid output from the cell refinement chamber into a first solution having a first concentration of one or more cells of interest and a second solution having a concentration of the one or more cells of interest which is less than that of the first solution, wherein the cells of interest comprise non-fat cells isolated from an adipose tissue sample.

In accordance with an aspect of the present disclosure there is provided a sterile and substantially isolated adipose tissue processing system. The system comprises a tissue processing chamber including an inlet, an outlet, and at least one mesh filter disposed between the inlet of the tissue processing chamber and the outlet of the tissue processing chamber, a waste collection chamber included in a same enclosure as the tissue processing chamber, the waste collection chamber including an inlet in fluid communication with the outlet of the tissue processing chamber, and one of a debris removal chamber including a debris removal mechanism, and a sample collection chamber included in the same enclosure as the tissue processing chamber and in fluid communication with the tissue processing chamber.

In accordance with an aspect of the present disclosure there is provided a method of processing an adipose tissue sample in a tissue processing system. The method comprises introducing an adipose tissue sample to be processed into a first chamber through an inlet port of the first chamber, treating the adipose tissue sample in the first chamber, and transferring cells from the first chamber through an outlet of the first chamber into a second chamber included in a same enclosure as the first chamber through an inlet of the second chamber.

In accordance with some embodiments treating the adipose tissue sample comprises dissociating the adipose tissue sample.

In accordance with some embodiments treating the adipose tissue sample comprises removing excess fluids from the adipose tissue sample in the first chamber.

In accordance with some embodiments treating the adipose tissue sample comprises washing the adipose tissue sample in the first chamber using a rinsing solution.

In accordance with some embodiments treating the adipose tissue sample comprises washing the adipose tissue sample in the first chamber using a rinsing solution and dissociating the adipose tissue sample in the first chamber using a dissociation solution comprising at least one enzyme.

In accordance with some embodiments the dissociation solution comprises collagenase.

In accordance with some embodiments the dissociation solution comprises collagenase, deoxyribonuclease and hyaluronidase.

In accordance with some embodiments dissociating the adipose tissue sample using a dissociation solution occurs at about 37 degrees Celsius.

In accordance with some embodiments the method further comprises the removal of debris using a mesh filter included in the second chamber.

In accordance with some embodiments the mesh filter has a pore size of between 15 micrometers and 100 micrometers.

In accordance with some embodiments the method further comprises retaining the sample within the first chamber and transferring a waste fluid through a mesh filter included in the first chamber and a first outlet of the first chamber into a third chamber included in the same enclosure as the first chamber through an inlet of the third chamber.

In accordance with some embodiments the method further comprises enriching for non-fat cells population using a microfluidic device.

In accordance with some embodiments the non-fat cells comprise stem cells.

In accordance with some embodiments the method further comprises harvesting cells from the tissue processing system.

In accordance with some embodiments the method further comprises processing the cells in a downstream processing apparatus in fluid communication with an outlet of the second chamber and including at least one microfluidic device configured to separate the cells into a first solution having a first concentration of non-fat cells and a second solution having a concentration of non-fat cells which is less than that of the first solution.

In accordance with some embodiments the cells harvested are stromal vascular fraction cells.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. All drawings should be considered schematic unless otherwise indicated. In the drawings:

FIG. 1A is a flow chart of a method in accordance with an embodiment of the present disclosure;

FIG. 1B is a flow chart of a method in accordance with an embodiment of the present disclosure;

FIG. 2A is a schematic diagram of a sample processing device in accordance with an embodiment of the present disclosure;

FIG. 2B is a schematic diagram of a flow control device in accordance with an embodiment of the present disclosure;

FIG. 2C is a schematic diagram of a flow control device in accordance with an embodiment of the present disclosure;

FIG. 2D is a schematic diagram of a sample processing device in accordance with an embodiment of the present disclosure;

FIG. 2E is a schematic diagram of a sample processing device in accordance with an embodiment of the present disclosure;

FIG. 2F is a schematic diagram of a sample processing device in accordance with an embodiment of the present disclosure;

FIG. 2G is a schematic diagram of a sample processing device in accordance with an embodiment of the present disclosure;

FIG. 3A is an elevational view of a sample processing device in accordance with an embodiment of the present disclosure;

FIG. 3B is an isometric view of the sample processing device of FIG. 3A;

FIG. 3C is an exploded view of a portion of a chamber of the device of FIG. 3A;

FIG. 3D is an exploded view of a portion of a chamber of the device of FIG. 3A;

FIG. 3E is an cross sectional view from the side of a portion of a chamber of the device of FIG. 3A;

FIG. 3F is an elevational view of a sample processing device of FIG. 3A including optional clamps;

FIG. 4 is an elevational view of a sample processing device in accordance with an embodiment of the present disclosure;

FIG. 5A is an elevational view of a chamber of a sample processing device in accordance with an embodiment of the present disclosure;

FIG. 5B is a cross sectional view from the side of a portion of the chamber of FIG. 5A;

FIG. 6A is an elevational view of a chamber of a sample processing device in accordance with an embodiment of the present disclosure;

FIG. 6B is a cross sectional view from the side of the chamber of FIG. 6A;

FIG. 7 is a cross sectional view from the side of a chamber of sample processing device in accordance with an embodiment of the present disclosure;

FIG. 8A is an elevational view of a chamber of a sample processing device in accordance with an embodiment of the present disclosure;

FIG. 8B is an exploded view of the chamber of FIG. 8A;

FIG. 9A is an elevational view of a chamber of a sample processing device in accordance with an embodiment of the present disclosure;

FIG. 9B is an exploded view of the chamber of FIG. 9A;

FIG. 10A is an elevational view of a portion of a sample processing device in accordance with an embodiment of the present disclosure;

FIG. 10B is an exploded view of the portion of a sample processing device of FIG. 10A;

FIG. 11 is an elevational view of a sample processing device in accordance with an embodiment of the present disclosure;

FIG. 12 is an elevational view of a sample processing device in accordance with an embodiment of the present disclosure;

FIG. 13A is an elevational view of a sample processing device in accordance with an embodiment of the present disclosure;

FIG. 13B is a cross sectional view of a portion of chamber of the device of FIG. 13A;

FIG. 13C is a cross sectional view of a portion of chamber of the device of FIG. 13A;

FIG. 14 is an elevational view of a sample processing device in accordance with an embodiment of the present disclosure;

FIG. 15A is an illustration of a portion of a microfluidic device included in some embodiments of the present disclosure;

FIG. 15B is an illustration of a microfluidic device included in some embodiments of the present disclosure;

FIG. 15C is an illustration of a microfluidic device included in some embodiments of the present disclosure;

FIG. 15D is an illustration of a microfluidic device included in some embodiments of the present disclosure;

FIG. 15E is an illustration of a microfluidic device included in some embodiments of the present disclosure;

FIG. 16 is an elevational view of a sample processing device in accordance with an embodiment of the present disclosure;

FIG. 17 is an illustration of a microfluidic device included in some embodiments of the present disclosure;

FIG. 18A is a photograph of a fluid processed in an embodiment of the present disclosure; and

FIG. 18B is a photograph of a fluid processed in an embodiment of the present disclosure.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

The term “sample” as used herein may include a tissue, an animal tissue, a connective tissue, a muscle tissue, a nervous tissue, an epithelial tissue, a solid tumor tissue, a placenta tissue, an umbilical cord tissue, a tissue containing stem cells, a pancreatic tissue, a brain tissue, a heart tissue, an adipose tissue, a solid tissue, pancreatic islets, a pancreatic tissue, a liver tissue, a tissue containing progenitor cells and/or stem cells, a skin tissue, a ligament tissue, a bone tissue, a mesenchymal tissue, a tissue containing cells of interest, a tissue containing hepatocytes, a tissue containing fibroblasts, a tissue containing keratinocytes, a tissue containing chondrocytes, a tissue containing cardiomyocytes, a tissue containing oocytes, a tissue containing nerve cells, an umbilical cord, a tissue from an umbilical cord, cells imbedded in a matrix, cells embedded in an extracellular matrix, plant tissues, and other tissue pieces of biological origin, whether dead or alive. The term “sample” as used herein may also include a multi cell organism, a complete organism, parasites, biomass, a food sample, hamburger patties, beef, lamb, chicken, pork, turkey, shell fish, fish, poultry, ground beef, ground meat, ground chicken, ground turkey, ground pork, ground lamb, hot dogs, corn dogs, mixed meat, candy bars, and peanut butter.

The term “microfluidic device” as used herein may refer to a device having at least one fluidic channel formed on substantially one surface, which may be substantially planar or curved, and at least one lateral channel dimension smaller than about 1 mm. The lateral channel dimension may be for example, the width or the depth of the channel.

It has been found to be desirable to have a method for effective isolation of cells of interest from a tissue, and to have a device that makes isolation of cells from tissues easy and safe. For research and clinical applications, it has been found to be desirable that the multiple acts of processing tissue samples, such as those listed above, be streamlined so that human error can be minimized. Further, it has been found to be important that tissue samples are processed in a substantially “isolated” environment, where barriers are provided to isolate the samples from direct physical contact, or fluid contact, for example, through unfiltered air flow, with the external environment and/or operating personnel to minimize or avoid contamination and infection risks. It has also been found to be desirable to have a system and device for tissue processing where many components and compartments are integrated as one piece to provide a substantially isolated environment to the sample. It is preferable that a system and device for tissue processing is easy to use, easy to manufacture, and has low risk of failure. For many clinical and research applications, it may also be preferable that any parts of the device and system in direct contact with tissue samples are sterile and disposable.

Aspects and embodiments of the present disclosure provide a method for isolating certain constituent cell populations from a tissue sample. Other aspects and embodiments of the present disclosure provide a device for enabling the method for isolating certain constituent cell populations from a tissue sample in an integrated, streamlined, safe, and easy-to-use manner.

Aspects and embodiments of the present disclosure provide an integrated device comprising multiple compartments for tissue sample processing, which may include, but are not limited to, compartments configured and arranged for sample collection, washing, stratification, mixing, heating, cooling, filtering, digestion, storage, fluid transfer and manipulation, cell labeling, sample treatment, dissociation, waste fluid collection, clump removal, debris removal, cell concentration, cell enrichment, cell isolation, cell incubation, growth, culturing, differentiation, expansion, etc. Integrated devices in accordance with embodiments of the present disclosure may also include valving for the purpose of, for example, controlling fluid flow between compartments. Such devices may be useful for integrating and streamlining multiple acts of tissue sample processing, for example, isolating cells from tissues, and may facilitate multiple functions such as enzymatic digestion, tissue dissociation, washing, waste liquid collection, debris removal, cell concentration, labeling using antibodies, labeling using magnetic beads, cell expansion, etc. Such devices may be particularly useful for applications where safety, ease of use, and ease of manufacturing are important. Some aspects and embodiments of the present disclosure comprise methods for using such device.

One embodiment of the presently disclosed method for isolating cells from a tissue comprises, but is not limited to, dissociating the tissue, releasing the constituent cells, collecting the released cells, and removing tissue debris. The method may further comprise a tissue clean up act before tissue dissociation. The tissue clean up act may comprise removing or draining unwanted or excess fluids from the tissue sample. Such unwanted fluids may include blood, body fluids, saline solutions, tumescent solution, anesthetics, components that may interfere with potential downstream use of the cells, etc. The tissue clean up act may further comprise rinsing or washing the tissue using a rinsing solution. The method may further include one or more acts to enrich or purify the released cells. In addition, the method may further comprise collection of waste fluids from the process. Another embodiment of the presently disclosed method for isolating cells from a tissue comprises, but is not limited to, removing excess fluids from a tissue, dissociating the tissue and releasing the constituent cells, and removing unwanted cells and debris. The method may further comprise one or more of washing the tissue sample, concentrating the cells of interest, washing the cells of interest, and performing immuno-separation using, for example, antibodies. In one embodiment, concentrating and/or washing the cells of interest may be performed using at least one microfluidic device. In another embodiment, one or more acts may employ centrifugation. In yet another embodiment, one or more acts may be performed utilizing hollow fibers.

For example, in one embodiment of the present disclosure there is provided a method for isolating a non-fat cell population from an adipose tissue. The method includes, but is not limited to, removing excess fluids from the adipose tissue, washing the adipose tissue with a buffer solution, dissociating the tissue using, for example, ultrasound or a dissociation solution containing enzymes, removing fat cells, free oil, matrix fibers and tissue debris, reducing red blood cells, and enriching cells of interest. The cell enrichment act may be achieved using a centrifuge, a filter, or a microfluidic device. The method may further comprise one or more of lymphocyte reduction, cell washing, and immuno-separation. The acts of removing excess fluids from the adipose tissue, washing the adipose tissue with a buffer solution, dissociating the tissue, removing fat cells, free oil, matrix fibers and tissue debris, and cell washing may be performed using, for example, settling under gravity, centrifugation, and/or a strainer comprising a mesh filter.

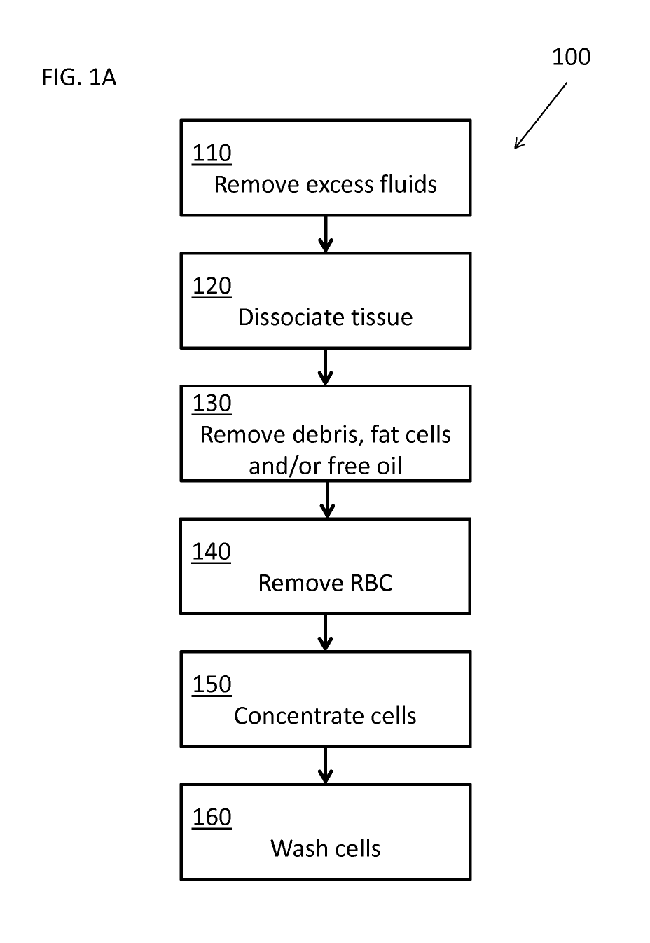

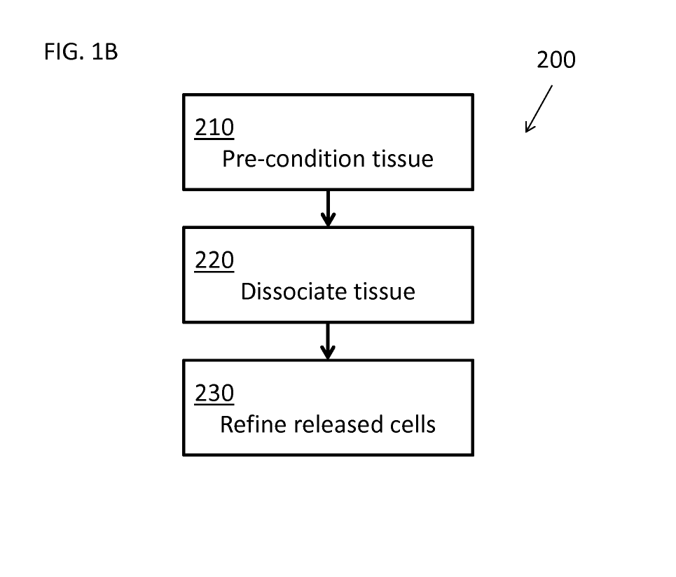

A flow chart of one embodiment of a method for isolating a non-fat cell population from an adipose tissue is shown in FIG. 1A indicated generally at 100. During liposuction procedures, tumescent fluids are often introduced to the patient to minimize blood loss, make the tissue firm, and provide local anesthesia. The tumescent solution may contain lidocaine at 0.05% and epinephrine at 1:1,000,000 concentration. The method includes an act (act 110) of removing excess fluids from the lipoaspirate fat tissues. The excess fluids may comprise blood and often tumescent fluids, which may interfere with downstream processing acts and isolation of cells of interest. In one embodiment, a sample of the excess fluids removed may be stratified into a fat tissue layer and an excess fluid layer using gravity settling or centrifugation, because the fat tissues are of lower density than the excess fluids. The fat tissue layer and the excess fluids may then be separated to different containers to separate the fat tissue from the excess fluids. A wash solution comprising, for example, a salt solution, a lactated Ringer's solution, Hanks balanced salt solution, or a phosphate-buffered saline solution may be applied to the fat tissue to wash the tissue, and the stratification process may be repeated to wash the fat tissue and remove the excess fluid more thoroughly. In another embodiment, the excess fluids may be drained using a strainer comprising a mesh. A wash solution may be added to the fat tissue and drained using the strainer to wash the tissue. This wash process may be repeated. In some embodiments, the strainer may comprise pores with pore sizes of from about 30 micrometers (μm) to about 1 millimeter (mm), for example, about 30 μm, about 50 μm, about 70 μm, about 85 μm, about 100 μm, about 120 μm, about 140 μm, about 200 μm, about 300 μm, about 500 μm, about 700 μm, or about 1 mm. In other embodiments, the strainer may comprise pores having pore sizes of from about 70 μm to about 500 μm, for example, about 70 μm, about 100 μm, about 140 μm, about 200 μm, about 300 μm, or 500 μm. More specifically, the strainer may comprise a mesh filter having pore sizes of from about 70 μm to about 200 μm, for example, about 80 μm, about 90 μm, about 100 μm, about 120 μm, about 140 μm, about 170 μm, or about 200 μm. In another embodiment of the present disclosure, the strainer has a pore size smaller than the tissue so that the tissue is retained by the strainer. For efficient removal of excess fluids, a wash act comprising adding a wash solution and removing the wash solution may be applied from about one to about ten times, for example, once, twice, three times, four times, five times, six times, eight times, or ten times. The ratio between the volume of the fat sample and the volume of the wash solution added for each wash may be between about 1:0.2 and about 1:10, for example, about 1:0.2, about 1:0.3, about 1:0.5, about 1:0.7, about 1:1, about 1:2, about 1:3, about 1:5, or about 1:10. For example, 100 ml of lipoaspirate fat tissues collected using tumescent liposuction may be mixed with 100 ml of lactated Ringer's solution and drained using a nylon mesh having pores of about 140 μm in pore size. This process may be performed three times to complete the excess fluid removal. In another embodiment, each washing act comprises adding to and removing from the sample a wash solution having a volume of between 0.6 times and 4 times the sample volume, for example, 0.6, 0.8, 1, 1.2, 1.5, 1.8, 2, 2.5, 3 or 4 times the sample volume, and the washing act is performed once, twice, three times or four times. In another embodiment, the excess fluid removal act may combine a stratification act using gravity followed by draining using a strainer. In yet another embodiment, a wash solution may be added to and mixed with the unprocessed fat tissue to dilute the excess fluids followed by stratification or draining the fluids using a mesh strainer. Adding a wash solution may make stratification or draining more effective.

In another embodiment of the present disclosure, the excess fluid removal act may be performed by putting the sample in a container having an outlet and then draining the excess fluid without using a strainer. In one embodiment, the container may further comprise means for fluid control, for example, a pinch valve. To perform the removal of excess fluids, the excess fluids may be drained through the outlet, and when the sample approaches the outlet, the outlet can be closed off using the fluid control means. The outlet may have a size smaller than the tissue sample or a large size that allows for the tissue sample to pass through. The act may be performed manually or with the aid of a sensor, for example, an optical sensor or an infrared sensor, which detects the sample with respect to the outlet. A wash solution may be added to the tissue sample to wash or rinse the sample, and the excess fluid removal act may be repeated to clean up the tissue sample. The second act of the method shown in FIG. 1A (act 120) is to dissociate the fat tissue. The fat tissue may be disassociated using ultrasound. The fat tissue may be disassociated using a dissociation solution. The dissociation solution may comprise an enzyme that breaks down the extra cellular matrix of the tissue. The dissociation solution may comprise collagenase, protease, proteinase, neutral protease, elastase, hyaluronidase, lipase, trypsin, liberase, DNase, deoxyribonuclease, pepsin, or mixtures thereof. The dissociation solution may comprise collagenase at a concentration of between 0.1 mg/ml and 10 mg/ml, for example, about 0.1 mg/ml, about 0.2 mg/ml, about 0.3 mg/ml, about 0.5 mg/ml, about 0.75 mg/ml, about 1 mg/ml, about 1.2 mg/ml, about 1.5 mg/ml, about 2 mg/ml, about 3 mg/ml, about 4 mg/ml, about 5 mg/ml, about 7 mg/ml, or about 10 mg/ml. The dissociation solution may comprise trypsin. The dissociation solution may comprise collagenase and deoxyribonuclease. The dissociation solution may comprise collagenase, hyaluronidase and deoxyribonuclease. The dissociation solution may comprise between 0.2 mg/ml and 5 mg/ml of collagenase, 0.1 mg/ml and 4 mg/ml of hyaluronidase and between 1 units and 400 units of deoxyribonuclease where each unit is defined as enzymatic activities that produces a change on A260 of 0.001 per minute per ml at pH 5.0 at 25 degrees Celsius using DNA as substrate at a Mg++ concentration of 4.2 mM. The dissociation solution may further comprise calcium ions and/or magnesium ions. The dissociation solution may include magnesium or calcium ions at a concentration of between 0.1 mM and 10 mM, for example, about 0.1 mM, about 0.2 mM, about 0.3 mM, about 0.5 mM, about 0.7 mM, about 1 mM, about 1.5 mM, about 2 mM, about 3 mM, about 4 mM, about 5 mM, about 6 mM, about 7 mM, about 8 mM, or about 10 mM.

After adding the dissociation solution, the tissue may be incubated at a certain temperature, for example, about 37 degrees Celsius, for a certain period of time, for example, from about 5 minutes to about 30 hours. During incubation, the tissue and the dissociation solution may be mixed intermittently and/or continuously to facilitate efficient reaction. The tissue dissociation act or the incubation act may be performed at 37 degrees Celsius for between about 10 minutes to about 120 minutes, for example, about 10 minutes, about 15 minutes, about 20 minutes, about 30 minutes, about 45 minutes, about 60 minutes, about 75 minutes, about 90 minutes, or about 120 minutes, with intermittent gentle agitation of the tissue sample in the dissociation solution, where the agitation occurs more frequent than every 3 minutes, for example, every second, every 2 seconds, every 3 seconds, every 5 seconds, every 10 seconds, every 20 seconds, every 30 seconds, every 45 seconds, every 60 seconds, every 90 seconds, every 120 seconds, or every 180 seconds.

At the end of the dissociation act, metal ion chelators such as ethylenediaminetetraacetic acid (EDTA) may be added to sequester metal ions and halt the activities of the enzymes in the dissociation solution, and the temperature may be lowered to between about 4 degrees Celsius and 30 degrees Celsius, for example, room temperature, about 25 degrees Celsius, about 22 degrees Celsius, about 18 degrees Celsius, about 15 degrees Celsius, about 12 degrees Celsius, about 8 degrees Celsius, or about 4 degrees Celsius. The temperature may be kept at around room temperature, for example, around 25 degrees Celsius, or between 18 degrees Celsius and 28 degrees Celsius, after incubation. In another embodiment, plasma, platelet enriched plasma, or serum may be added to inhibit the enzymes in the dissociation solution after the dissociation act.

The third act of the method of FIG. 1A (act 130) is to remove free oil, matrix fibers, tissue debris, and unwanted cells, for example, fat cells. Fat cells, matrix fibers and tissue debris may be substantially removed using a mesh strainer comprising pores having pore sizes of between about 10 μm and about 70 μm, for example, about 10 μm, about 15 μm, about 20 μm, about 25 μm, about 30 μm, about 35 μm, about 40 μm, about 50 μm, about 60 μm, or about 70 μm. In another embodiment, the dissociated tissue sample is passed through a mesh with pore sizes of between about 20 μm and about 50 μm, for example, about 20 μm, about 22 μm, about 25 μm, about 30 μm, about 35 μm, about 40 μm, and about 50 μm. Filtrates that pass the mesh strainer may be collected. Alternatively, fat cells, matrix fibers, and tissue debris may be substantially removed using centrifugation.

The fourth, fifth and sixth acts of the method of FIG. 1A (acts 140, 150, and 160) include reducing red blood cells (RBC), concentrating the cells of interest, and washing the cells, respectively. The order of these three acts may be interchangeable. For example, in one embodiment cells may be concentrated first, washed and then RBC reduced. In another embodiment, cells may be washed first before they are concentrated. In yet another embodiment, cells may be washed and concentrated at the same time. The concentration act may be advantageously performed in applications where smaller volume is desired. For example, culturing cells isolated from fat tissue is often conducted in research. To get a higher seed cell density in a cell culture flask and to increase the culture efficiency, cells may be concentrated. Isolated cells may also be used for transplantation or injection into a human or an animal, where high cell concentration is often desired to yield better outcomes. Concentration of cells may also have the advantage of substantially removing reagents used in previous acts, for example, enzymes in the dissociation solution, which may inhibit cell growth or cause detrimental effects when transplanted into an animal or a human patient. In one embodiment, a microfluidic device may be used to concentrate the cells of interest and/or to remove red blood cells. A microfluidic device may be configured to simultaneously achieve the fourth, fifth and/or sixth acts. Further, a microfluidic device may be configured to remove lymphocytes to reduce the potential for an immune reaction. In another embodiment, the concentration act may be achieved using centrifugation. In yet another embodiment, the concentration act may be achieved using a membrane filter. In yet another embodiment, the concentration act may be achieved using hollow fibers, for example, hollow fiber membrane filters. In yet another embodiment, the red blood cell reduction act may be achieved using a red blood cell lysis solution, for example, ammonium chloride, where red blood cells are selectively lysed.

The sixth act of the embodiment shown in FIG. 1A (act 160) is to wash the cells of interest and/or to transfer the cells of interest into a desired buffer. Centrifugation, buffer exchange, and/or dialysis methods may be employed. Alternatively, a microfluidic device may also be configured to perform this act. This act further reduces the residual reagents used in previous acts, and may be desired when the cells of interest are to be used for clinical transplantation. In some embodiments, however, acts 140-160 may be skipped.

In one embodiment of the present disclosure, a method comprises pre-conditioning of tissue, dissociation of tissue, and refinement of released cells. A flow chart of this embodiment of this method is shown in FIG. 1B, indicated generally at 200. In one embodiment, the tissue pre-conditioning act (act 210) comprises draining waste fluids, removing waste fluids, removing excess fluids, rinsing the tissue sample, washing the tissue sample, and/or mincing the tissue sample. Mincing may be advantageous when the tissue sample comprises large chunks that are difficult to digest or dissociate with enzymes. The tissue pre-conditioning act may be achieved using aspects and embodiments for isolating a non-fat cell population from an adipose tissue disclosed in the present disclosure. For example, the tissue pre-conditioning act may comprise retaining the tissue sample in a first container, while passing excess fluids such as blood, buffer solution or other bodily fluids to a second container. The retention of the tissue sample may be achieved using a mesh in the first container. In one embodiment the mesh has pore sizes of between about 70 μm and about 300 μm, for example, about 80 μm, about 90 μm, about 100 μm, about 120 μm, about 140 μm, about 170 μm, about 200 μm, or about 300 μm. Alternatively, the retention of the tissue sample may be achieved using a detector or a sensor which detects the location of the tissue sample with respect to the first container without using a mesh in the first container. The tissue pre-conditioning act may further comprise adding and removing a rinsing solution once or repeatedly to wash the tissue sample. Tissue pre-conditioning may also be achieved using centrifugation, where the tissue sample is separated from the excess fluids and/or waste fluids under a centrifugal force. Alternatively, the tissue pre-conditioning act may be omitted if the tissue is in conditions acceptable for dissociation and refinement.

In one embodiment, the tissue dissociation act (act 220) comprises incubating the tissue sample in a dissociation solution comprising at least one enzyme, for example, collagenase, protease, proteinase, neutral protease, elastase, hyaluronidase, lipase, trypsin, papain, liberase, DNase, deoxyribonuclease, pepsin, or a combination thereof, at a temperature suitable for enzyme digestion, for example, between about 32 degrees Celsius and about 38 degrees Celsius, for a duration of between about 3 minutes and 20 hours. In another embodiment, the tissue dissociation act comprises passing an ultrasound wave through the tissue sample. Cells are released from the tissue sample during the tissue dissociation act.

The refinement of released cell (act 230) may comprise cell concentration, cell washing, cell separation, cell isolation, debris removal, non-target cell removal, red blood cell reduction, or a combination of acts thereof, using a filter, a mesh, a hollow fiber, an antibody, a microfluidic device, or a centrifuge. For many applications, such as point of care applications and field applications, it may be desirable to perform the entire method in the present disclosure in within a short period of time, for example, 15 minutes, 20 minutes, 30 minutes, 45 minutes, 60 minutes, 90 minutes, or 120 minutes.

It is appreciated that many acts and embodiments disclosed herein may also be used for other tissue processing applications, and embodiments of the present disclosure are not limited to isolating non-fat cells from adipose tissues. For example, the embodiments may be applied to dissociation of solid tumors, placenta tissue, tissue containing stem cells, pancreatic tissue, brain tissue, heart tissue, pancreatic islets, pancreatic tissue, liver tissue, tissues containing progenitor cells and/or stem cells, skin tissue, ligament tissue, connective tissue, mesenchymal tissue, tissue containing cells of interest, or other tissue pieces. Many acts and embodiments disclosed herein for isolating a non-fat cell population from an adipose tissue may also be used in research studies and pharmacological test systems. Isolation of cells, for example, hepatocytes, fibroblasts, keratinocytes, chondrocytes, cardiomyocytes, oocytes, nerve cells and stem cells, as well as in vitro cultivated tissues may be performed for the physiological, metabolic and functional studies or for drug testing in pharmacological test systems. Many acts and embodiments disclosed herein for isolating a non-fat cell population from an adipose tissue may also be used in tissue engineering for transplantation. Cells obtained using the disclosed methods and/or devices herein may be cultured in vitro to form in vitro cultured tissues for transplantation. For example, hepatocytes may be isolated and transplanted to cure chronic liver diseases or to substitute liver function after acute organ failure. Chondrocytes may be isolated and cultivated to replace damaged cartilage. Dermal fibroblasts and keratinocytes may be isolated to build up three-dimensional skin transplants to treat burning injuries, diabetic or other ulcers. Tumor cells from various tissues may be isolated and fused with dendritic cells for tumor immunotherapy. Adipose-derived stem cells may be isolated to generate functional cells and tissue.

It is also appreciated that many acts and embodiments disclosed herein may also be used to obtain pancreatic islet cells from pancreatic tissue. Transplantation of pancreatic islets of Langerhans is a promising viable treatment option for patients with type-1 diabetes. Patients who need to have pancreatic surgery, including complete removal of the pancreas due to chronic inflammation, may also be transplant candidates. Transplantation of islets may restore some of the functions of the removed organ. Clinical studies have shown that a number of diabetic patients who had received injections of isolated islets into the liver were insulin independent for several years. Human islets for transplantation may be isolated from donor pancreases using embodiments of the methods and/or the devices disclosed herein. Since availability of donor organs is often limited, high yields of isolated islets per organ is highly desired. Collagenase, or collagenase in combination with neutral protease, other enzymes and/or ultrasound, may be used to dissociate the supporting matrix of the pancreas.

In another embodiment of the present disclosure, solid tumors removed from patients during surgery procedures may be dissociated and prepared to obtain tumor cells for molecular testing, genetic testing, drug testing and/or other testing and analysis to acquire information that may alter, influence, benefit, determine, or optimize treatment decisions. Cancer cells or tumor cells processed using the methods and/or the devices disclosed herein can be used directly for proteomics applications such as identification of biomarkers, testing against biomarkers, and mass spectrometry analysis, for RNA-based applications such as microarray hybridization and genetic analysis, for testing against drugs, and/or for cytology applications such as flow cytometry analysis and immunophenotyping. The cells that may be prepared from the present disclosure includes breast cancer cells, kidney cancer cells, liver cancer cells, lung cancer cells, nasopharyngeal cancer cells, ovarian cancer cells, and prostate cancer cells. Cells can also be used to purify proteins to test antibody-based cancer therapies. Alternatively, cells can be used to establish primary cell lines.

It is further appreciated that many acts and embodiments disclosed herein may also be used for food safety applications, such as the dissociation of food, for example, hamburger patties, beef, lamb, chicken, pork, turkey, shell fish, fish, poultry, ground beef, ground meat, ground chicken, ground turkey, ground pork, ground lamb, hot dogs, corn dogs, mixed meat, candy bars, peanut butter, etc. for food safety or other applications. Potential bacteria, viruses, yeast, parasites, and other foodborne pathogens, for example, Staphylococcus Aureus, Listeria Monocytogenes, Clostridium Botulinum, Salmonella, Escherichia coli, E. Coli O157:H7, etc., may be released and enriched from the dissociated food samples using aspects of the embodiments disclosed herein. The pathogens may then be detected using cell culture techniques, antibody based techniques such as lateral flow assays and enzyme-linked immunosorbent assay (ELISA), molecular techniques such as polymerase chain reaction (PCR), fluorescence in situ hybridization using peptide nucleic acid probes (PNA FISH), and enzymatic amplification or other techniques. Embodiments of the methods disclosed herein as methods for food sample preparation enable sensitive detection of pathogens, because pathogens embedded in the food sample may be released, enriched, and detected.

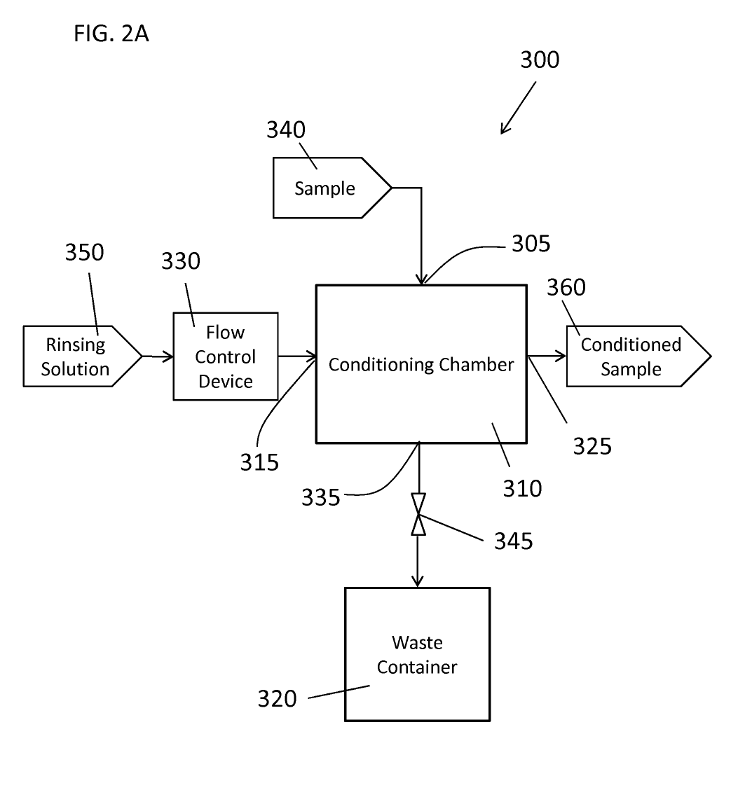

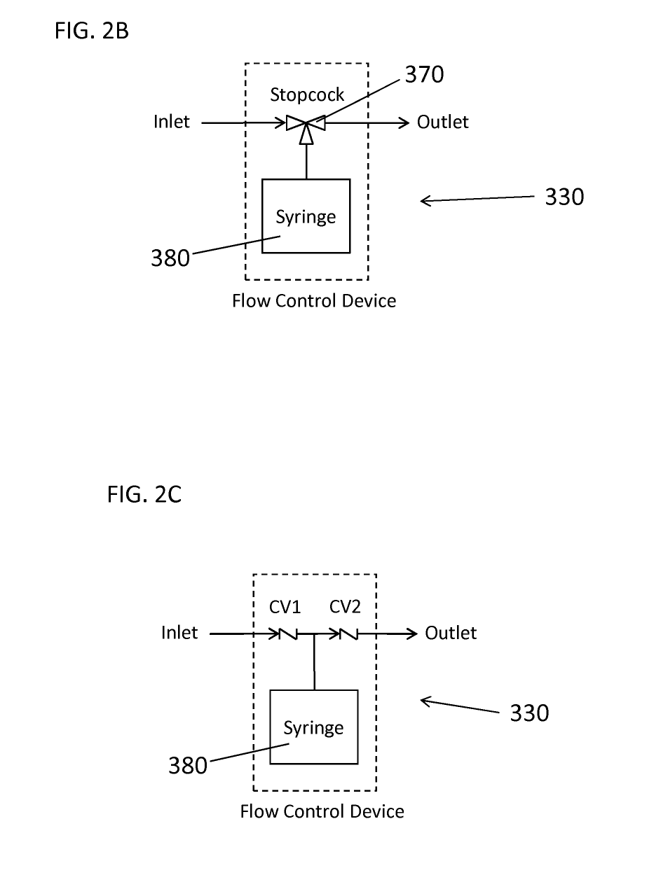

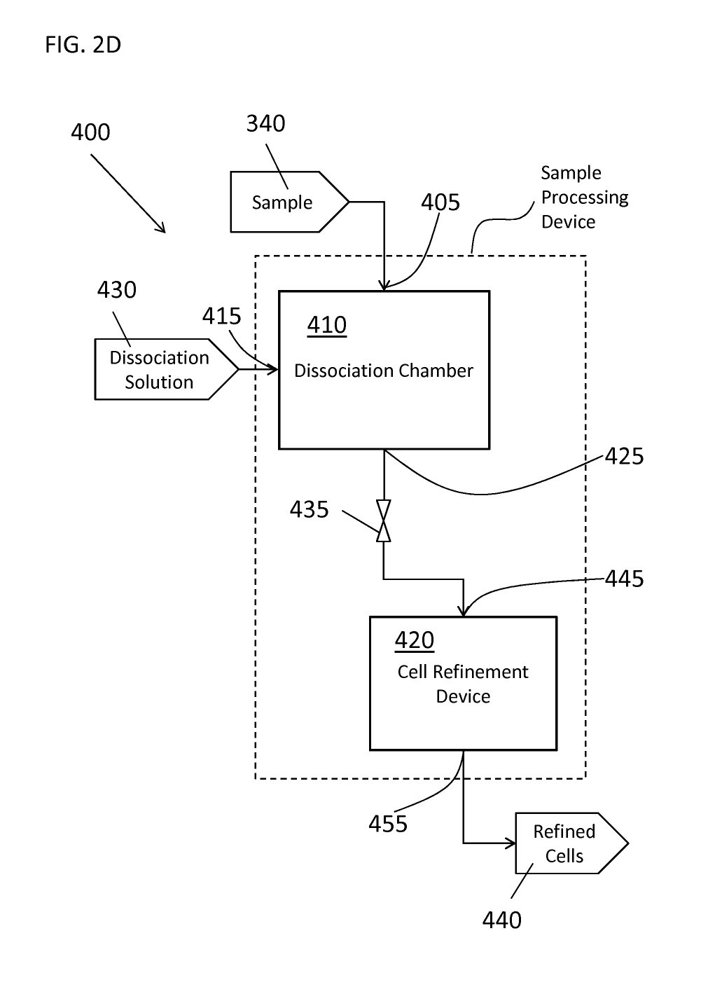

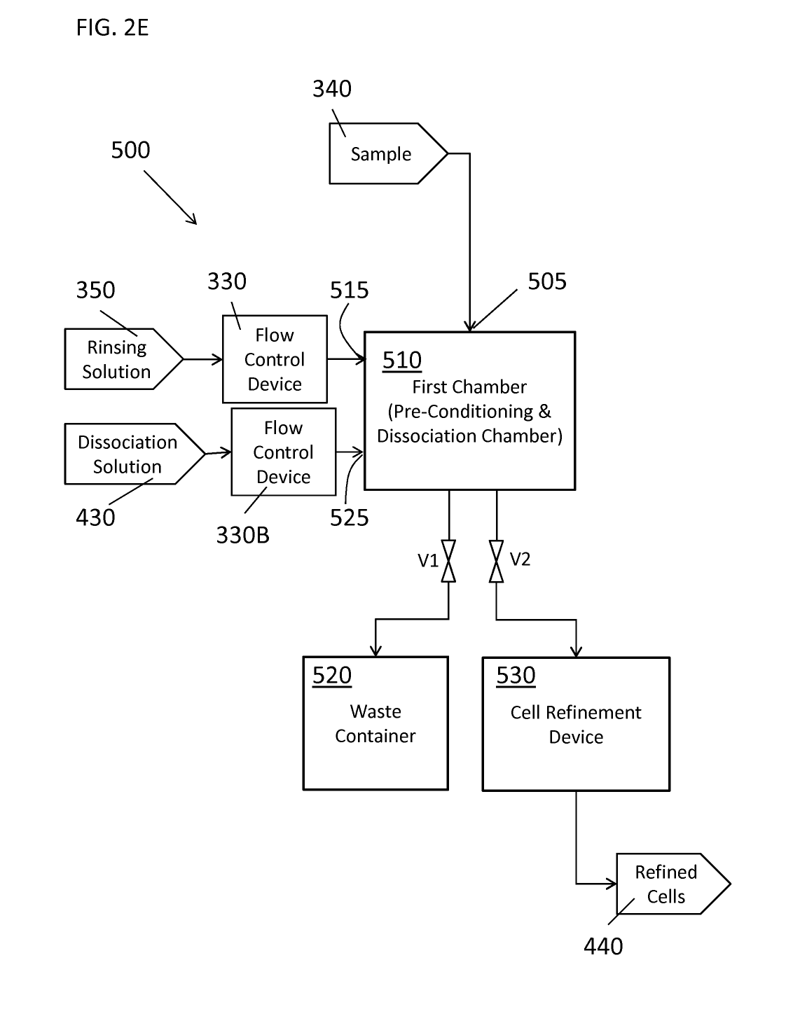

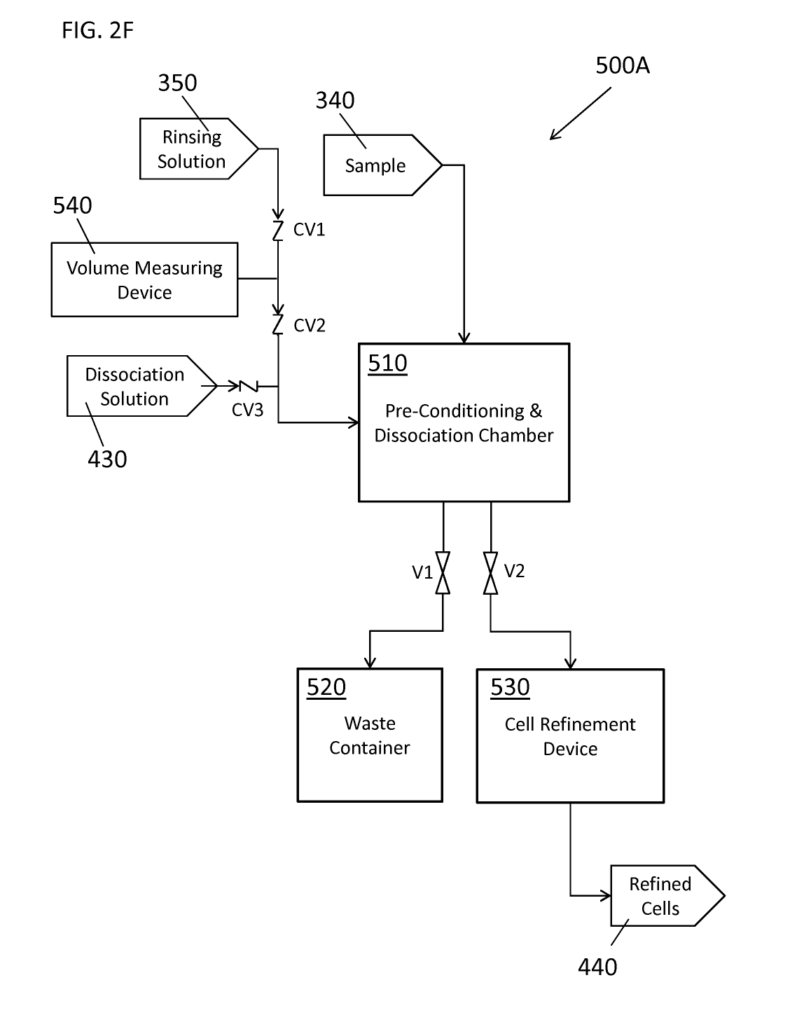

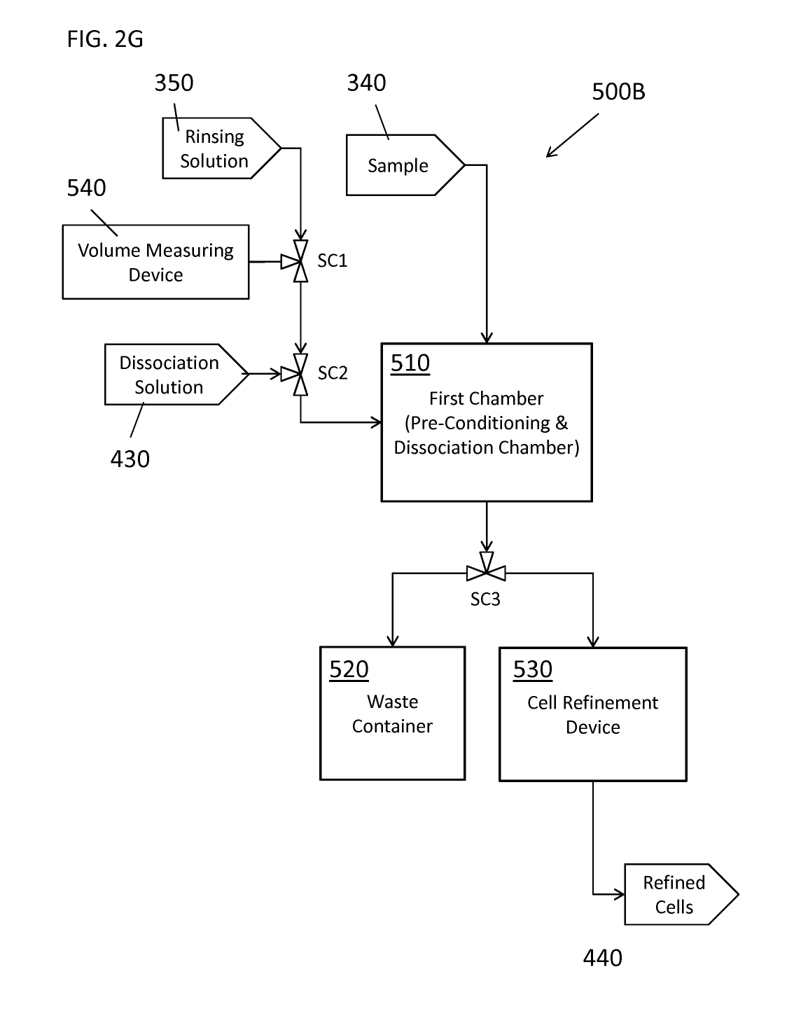

One embodiment of the present disclosure is a sample processing device shown schematically in FIG. 2A and indicated generally at 300. The sample processing device 300 comprises a sample conditioning chamber 310 and a waste chamber 320. The sample conditioning chamber 310 comprises a first inlet 305 for receiving a sample 320, for example, lipoaspirate, an adipose tissue sample from liposuction, a solid tissue, a food sample, etc. from a sample source 340, a second inlet 315 for receiving a rinsing solution, for example, a buffer solution, a saline solution, etc. from a source of rinsing solution 350, a first outlet 325 for collecting the sample 360 after it is conditioned, and a second outlet 335 connecting to the waste container 320. The second outlet 335 may comprise a means 345 to open and close the fluid connection between the conditioning chamber 310 and the waste container 320, for example, a valve, a pinch valve, a stopcock, etc. The sample conditioning chamber 310 allows a sample to drain off its excess fluids into the waste container, and to be washed using the rinsing solution. The conditioning chamber may further comprise a sensor, preferably close to the second outlet 335, to detect whether the sample is getting close to the outlet when excess fluids or rinsing solution is drained into the waste container. The conditioning chamber may further comprise a strainer placed between the first inlet and the second outlet, configured to retain the sample during sample washing, sample rinsing and removal of excess fluids. In some embodiments, the strainer may comprise a filter comprising pores with pore sizes of from about 30 μm to about 1 mm, for example, about 30 μm, about 50 μm, about 70 μm, about 85 μm, about 100 μm, about 120 μm, about 140 μm, about 200 μm, about 300 μm, about 500 μm, about 700 μm, or about 1 mm. In other embodiments, the strainer may comprise pores having pore sizes of from about 70 μm to about 500 μm, for example, about 70 μm, about 100 μm, about 140 μm, about 200 μm, about 300 μm, or 500 μm. The strainer may comprise a mesh filter having pore sizes of from about 70 μm to about 200 μm, for example, about 80 μm, about 90 μm, about 100 μm, about 120 μm, about 140 μm, about 170 μm, or about 200 μm. In another embodiment the strainer has a pore size smaller than the tissue so that the tissue is retained by the strainer.

The rinsing solution may enter the conditioning chamber via a flow control device 330, for example, a peristaltic pump, which controls the volume of the rinsing solution being added to the conditioning chamber. The flow control device may comprise at least one valve and varying-volume container. For example, the flow control device may comprise a stopcock 370 and a syringe 380 as schematically shown in FIG. 2B. To dispense a measured volume, the stopcock is first switched to a position where the inlet is fluidicly connected to the syringe. The plunger of the syringe is pulled to draw fluids from the inlet into the syringe. The stopcock is then switched to a position where the outlet is fluidicly connected to the syringe. Next, the plunger of the syringe is pushed to dispense the fluids out of the syringe via the outlet. Finally, the stopcock is again switched to fluidicly connect the syringe to the inlet, to complete a pumping cycle. The pumping cycle may be repeated until the desired volume of rinsing solution is added to the conditioning chamber. The flow control device may also comprise two check valves CV1, CV2, i.e. valves that allows for fluid flow in one direction, and a syringe, as schematically shown in FIG. 2C. To dispense a measured volume, the plunger of the syringe is first pulled and then pushed to complete a pumping cycle. The first check valve (CV1) is configured to allow fluids to flow from the inlet to the syringe, and second check valve (CV2) is configured to allow fluids to flow from the syringe to the outlet. The pumping cycle, comprising pulling and pushing the plunger to respectively draw fluids into and push fluids out of the syringe, may be repeated until the desired volume of rinsing solution is added to the conditioning chamber. Alternatively, the syringe in the flow control devices depicted in FIG. 2B or FIG. 2C may be replaced with a bag that can be inflated and deflated, or a container whose volume can be changed in a controlled manner.

Another embodiment of the present disclosure is a sample processing device shown schematically in FIG. 2D and indicated generally at 400. The sample processing device 400 comprises a sample dissociation chamber 410 and a cell refinement device 420. The dissociation chamber comprises a first inlet 405 to receive a sample, a second inlet 415 to receive a dissociation solution from a source of dissociation solution 430, and at least one outlet 425 fluidicly connected to the cell refinement device. The dissociation chamber is configured to dissociate the sample into smaller constituents, for example, single cells and small cell clumps. The dissociation solution may comprise an enzyme that breaks down the sample. For example, the dissociation solution may comprise collagenase, protease, proteinase, neutral protease, elastase, hyaluronidase, lipase, trypsin, liberase, DNase, deoxyribonuclease, pepsin, or mixtures thereof. The temperature may be controlled, for example, at about 37 degrees Celsius, and the sample and the fluids in the dissociation chamber may be mixed to facilitate efficient enzymatic reaction and uniform dissociation. One embodiment of the dissociation chamber is a flexible bag. The bag may be massaged, squeezed, rolled, rocked, shaken, partially squeezed and released back and forth, or otherwise agitated to facilitate mixing. The dissociation solution may also comprise a detergent, such as Tween 20 or Sodium dodecyl sulfate. When ultrasound is used to dissociate the sample, the dissociation solution may comprise a medium that efficiently conducts ultrasound. The dissociation chamber may comprise a strainer, for example, a mesh or a filter. The strainer may serve to hold the sample in a position for efficient dissociation, and/or to remove large debris from the dissociated sample. In some embodiments, the strainer may comprise a filter comprising pores with pore sizes of from about 30 μm to about 1 mm, for example, about 30 μm, about 50 μm, about 70 μm, about 85 μm, about 100 μm, about 120 μm, about 140 μm, about 200 μm, about 300 μm, about 500 μm, about 700 μm, or about 1 mm. In other embodiments, the strainer may comprise pores having pore sizes of from about 70 μm to about 500 μm, for example, about 70 μm, about 100 μm, about 140 μm, about 200 μm, about 300 μm, or 500 μm. The strainer may comprise a mesh filter having pore sizes of from about 70 μm to about 200 μm, for example, about 80 μm, about 90 μm, about 100 μm, about 120 μm, about 140 μm, about 170 μm, or about 200 μm. In another embodiment the strainer has a pore size smaller than the tissue so that the tissue is retained by the strainer.

The cell refinement device is connected to the dissociation chamber. In some embodiments, the sample processing device further comprises a valve 435 between the dissociation chamber and the cell refinement device. The valve may be closed to allow incubation of the sample with the dissociation solution, and opened to allow the released cells to enter the cell refinement device.

The cell refinement device is configured to receive the released cells from the dissociation chamber and to refine the released cells. In some embodiments, the cell refinement device comprises a chamber fluidicly connected to the dissociation chamber via an inlet 445, an outlet 455 for harvesting refined cells 440, and a strainer configured to remove large debris in the dissociated sample. The strainer may comprise a filter having pore sizes of between about 10 μm and about 100 μm, for example, about 10 μm, about 15 μm, about 20 μm, about 25 μm, about 30 μm, about 35 μm, about 40 μm, about 50 μm, about 70 μm, or about 100 μm. The strainer may also comprise a mesh with pore sizes of between about 20 μm and about 60 μm, for example, about 20 μm, about 22 μm, about 25 μm, about 30 μm, about 35 μm, about 40 μm, about 50 μm, and about 60 μm.

Another embodiment of the present disclosure is a sample processing device shown schematically in FIG. 2E and indicated generally at 500. The sample processing device 500 comprises a first chamber 510, a waste container 520 and a cell refinement device 530. The cell refinement device may comprise a mesh as disclosed above. The first chamber may serve as a pre-conditioning chamber in which a sample may be washed before dissociation, and a dissociation chamber, in which the sample may be dissociated into smaller constituents, for example, single cells or small aggregates of cells. The first chamber comprises a first inlet 505 for receiving a sample and a second inlet 515 for receiving a rinsing solution from a source of rinsing solution 350. In some embodiments, the rinsing solution and a dissociation solution may enter the first chamber via the same inlet. In other embodiments, the first chamber comprises a third inlet 525 for receiving the dissociation solution from a source of dissociation solution 430. The first chamber may further comprise a strainer, for example, a mesh or a filter, as described in the above paragraphs regarding dissociation chambers and conditioning chambers. The first chamber is fluidicly connected to the waste chamber and the cell refinement device. Valves V1 and V2 which may include, for example, pinch valves or clamp valves may be used to control fluid flows. For example, during sample preconditioning, valve V1 may be open to enable excess fluids and rinsing solution to flow into the waste container from the first chamber. Both V1 and V2 may be closed to allow incubation of the sample with the dissociation solution during sample dissociation. After dissociation, V2 may be opened to allow transfer of the dissociated sample to the cell refinement device.

In some embodiments of the present disclosure, an adipose tissue sample is pre-warmed to a certain temperature, for example, 37 degrees Celsius before being loaded into the First Chamber 510. The pre-warming as a treatment of the adipose tissue sample may shorten the time required for processing the tissue sample. In other embodiments of the present disclosure, an adipose tissue sample is photo-activated using a light having an average wavelength of between 300 nm and 700 nm, before being loaded into the First Chamber 510. Photo-activation may increase the potency of the cells in the tissue sample. In yet another embodiment of the present disclosure, an adipose tissue sample is treated using an acoustic wave, i.e. a sound wave to loosen up the tissue rendering the tissue sample easier to dissociate, before being loaded into the First Chamber 510.

The sample processing device may further comprise a flow control device 330 as described above for controlling the flow of rinsing solution entering the first chamber. A flow control device 330B, which may be similar to flow control device 330, may also be used to control flow of the dissociation solution injected into the first chamber. In some embodiments, the dissociation solution is loaded in a syringe before being injected into the first chamber.

It is appreciated that the sample processing device disclosed herein may have different variations and combinations. For example, as shown in FIG. 2F, an embodiment of the sample processing device indicated generally at 500A may employ two valves (V1, V2) to control the fluid flow between the first chamber, the waste container, and the cell refinement device. The flow control device may comprise two check valves (CV1, CV2) and a volume measuring device 540, for example, a syringe. The dissociation solution may be connected to the first chamber via a check valve CV3.

Another embodiment of the sample processing device of the present disclosure is shown schematically in FIG. 2G indicated generally at 500B, where at least 3 stopcocks (SC1, SC2, SC3) are used to control fluid flow. For example, during sample preconditioning, excess fluids and rinsing solution may be transferred into the waste container from the first chamber. The stopcock (SC3) may shut off flow exiting the first chamber to allow incubation of the sample with the dissociation solution during sample dissociation. After dissociation, the stopcock (SC3) may connect the first chamber to the cell refinement device to allow transfer of the dissociated sample to the cell refinement device.

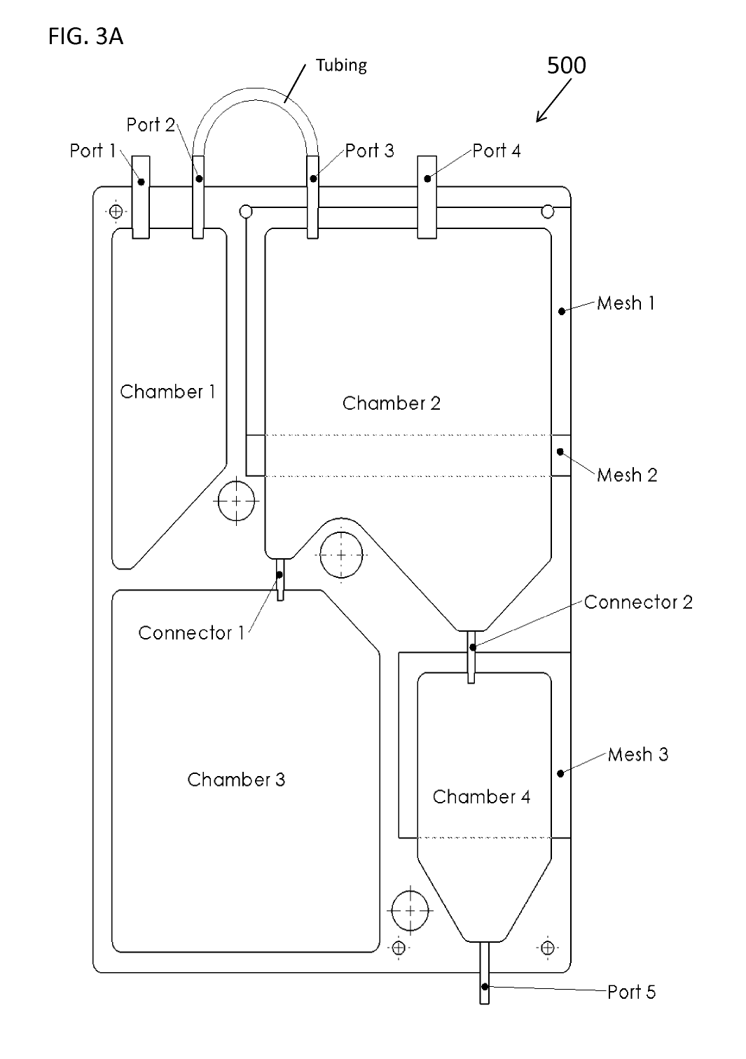

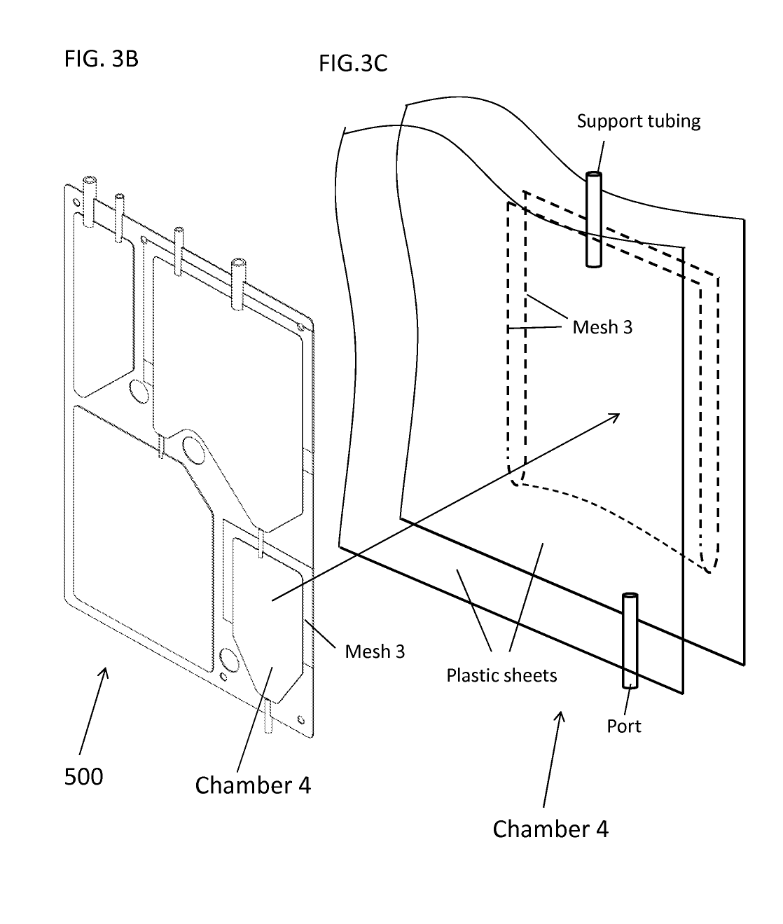

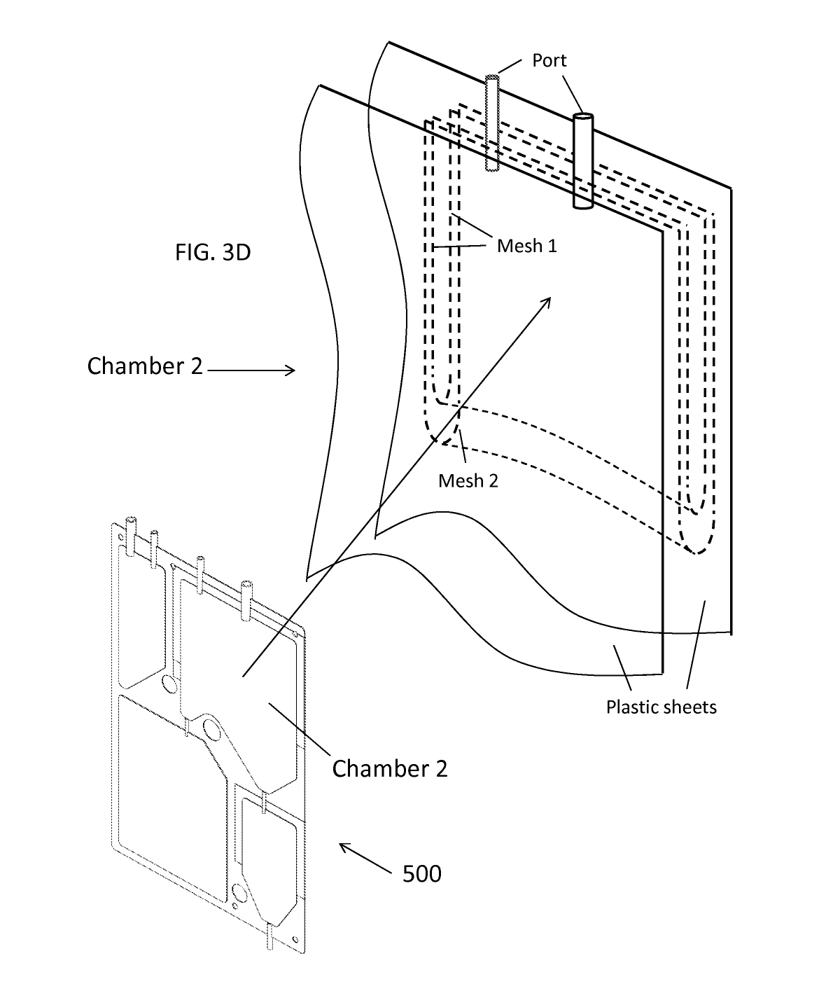

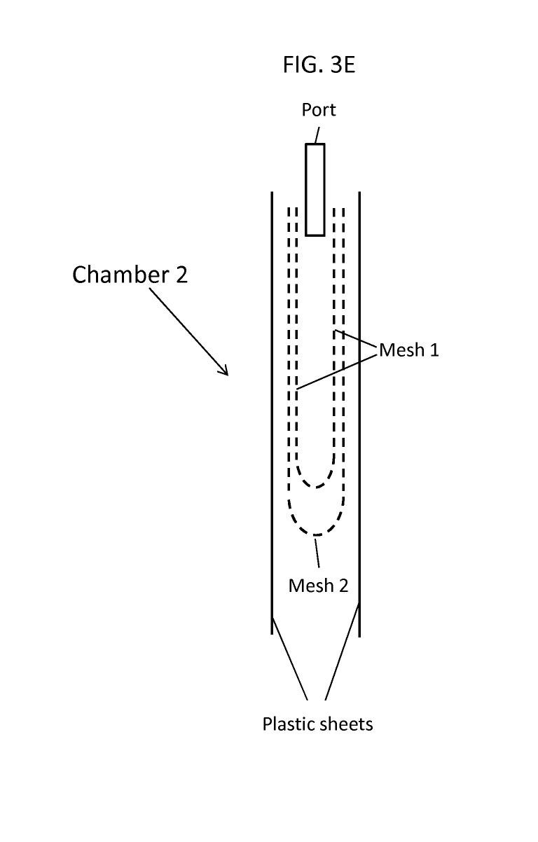

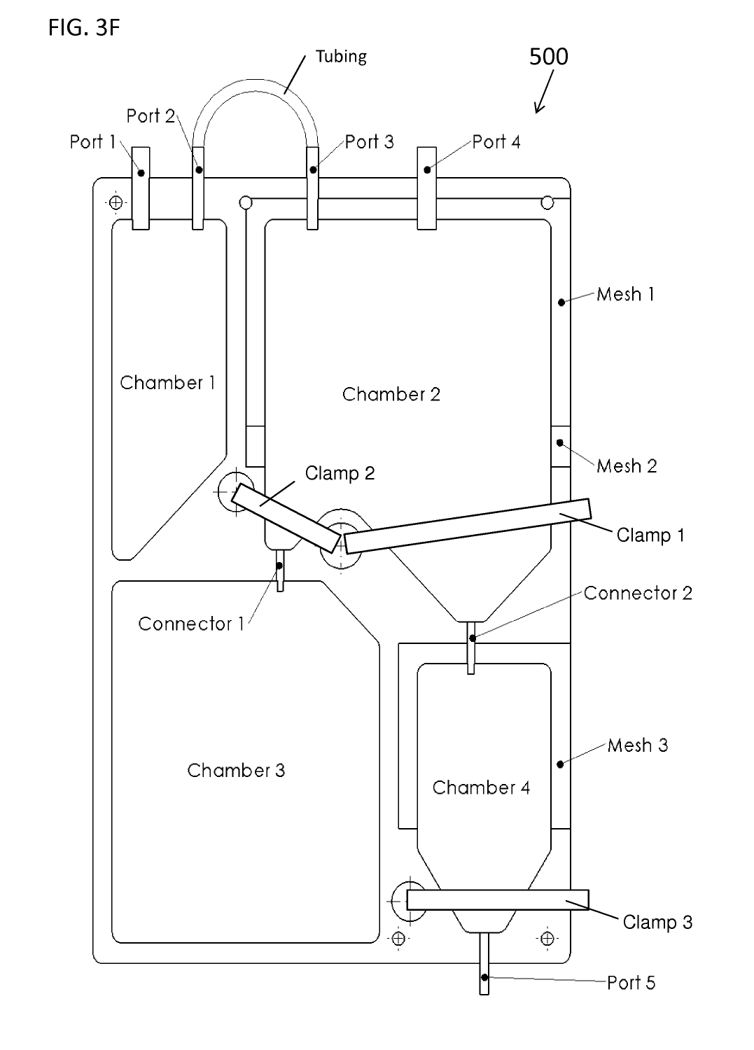

FIG. 3A shows an embodiment of the device shown schematically in FIG. 2E. The device comprises two plastic sheets joint together to form a plurality of chambers. The device may facilitate the methods for tissue processing disclosed herein in a streamlined, easy-to-use, safe, and cost effective manner. Chamber 1 is a measuring chamber, which may be inflated to a certain volume. The chamber comprises an inlet (Port 1) and an outlet (Port 2). Chamber 1 may be designed to take in a fluid, and dispense a certain predetermined volume of the fluid, thereby controlling the volume of fluids to be dispensed into Chamber 2 through an inlet (Port 3) for tissue processing. Port 2 and Port 3 may be fluidicly connected through a piece of tubing, which may be pinched off to fluidicly disconnect Port 2 from Port 3 using a pinch valve, a clamp valve, a stopcock, a check valve, or other valving mechanism(s). To operate Chamber 1, the connection between Port 2 and Port 3 is initially turned off. A fluid is introduced into Chamber 1 via Port 1 to fully or partially inflate the chamber. Port 1 is then shut off using, for example a pinch clamp, a pinch valve, a stopcock, a check valve, or other valving mechanism(s). Next, the valve between Port 2 and Port 3 is opened to allow the fluid in Chamber 1 to flow into Chamber 2 when Chamber 1 is deflated. The deflation of Chamber 1 may be accomplished by externally squeezing and/or compressing the chamber, by using gravity, by siphoning, or by other methods known in the art. Chamber 1 may be positioned higher than Chamber 2 to facilitate dispensing fluids to Chamber 2 using gravity. This process transfers a pre-determined amount of fluid to Chamber 2, the amount determined by the difference between the inflated volume and the deflated volume of Chamber 1. If a smaller volume of fluid is desired, Chamber 1 may be partially compressed, squeezed, and/or pinched off to control the volume of fluid entering and/or exiting Chamber 1. Alternatively, Chamber 1 may be deflated only partially to dispense a portion of the fluid in it. If a larger volume is desired, the inflation-deflation process may be repeated several times until the desired volume of fluids is transferred to Chamber 2.

Chamber 1, Port 1 and Port 2 may be an embodiment of the flow control device shown schematically in FIG. 2B or 2C.

Port 1 and Port 2 may comprise check valves, also known as one way valves that only allow fluids to enter and exit Chamber 1, respectively. The action of measuring and dispensing a set volume of fluid becomes very simple: decompressing Chamber 1 to allow fluids to enter via Port 1 and compressing Chamber 1 to push the fluids out via Port 2.

Alternatively, Chamber 1 may be a storage chamber which provides a pre-packaged solution that is needed for sample processing. For example, a lactated Ringer's solution, a balanced salt solution, a saline solution, a dissociation solution, a wash solution, a rinsing solution, a solution containing ethylenediaminetetraacetic acid (EDTA), and/or an enzyme solution, may be packaged in Chamber 1 as part of the device.

In another embodiment, the measuring chamber may comprise a syringe including a plunger, which may draw and/or dispense fluids of a pre-defined volume by pulling and pushing the plunger. In yet another embodiment, the measuring chamber may comprise a flexible tubing mounted on a peristaltic pump where fluid flows are controlled using the peristaltic pump.

Chamber 2 may be an embodiment of the first chamber 510 shown schematically in FIG. 2E. Chamber 2 may be a tissue washing chamber, comprising one or more inlets and outlets. Chamber 2 may also serve as a dissociation chamber, and may further comprise at least one mesh, for example, a filter mechanism including a screen, a semi-permeable membrane, and/or a porous or micro-porous membrane. A tissue sample, for example, blood, bone marrow, cerebrospinal fluid (CSF), amniotic fluid, lipoaspirate, a tumor biopsy sample, placenta tissue, tissue containing stem cells, pancreatic tissue, brain tissue, heart tissue, pancreatic islets, pancreatic tissue, liver tissue, tissue containing progenitor cells and/or stem cells, tissue containing cells of interest, tissue pieces etc., may be introduced or be loaded into Chamber 2 via an inlet (Port 4). Excess fluids from the sample may be drained through the mesh via Connector 1 into a waste collection chamber (Chamber 3). A wash solution may be added to Chamber 2 to wash and/or rinse the sample. The wash solution may be measured and dispensed into Chamber 2 via Chamber 1. Solutions to treat the sample may be added to alter the sample. Mixing means may be applied to Chamber 2 to make rinsing and washing more effective. For example, Chamber 2 may be massaged, squeezed gently, rocked, shaken, partially squeezed and released back and forth, or otherwise agitated to facilitate mixing. The waste fluid may then be drained to a waste collection chamber (Chamber 3). The outlets of Chamber 2 (Connectors 1 and 2) may be closed off using valving means during mixing to allow thorough mixing between the wash solution and the tissue sample before the waste fluid is drained. Clamps, for example, Clamp 1, Clamp 2, and/or Claim 3 as illustrated in FIG. 3F may be applied to pinch the chambers and close off fluid connections between chambers. The wash process may be repeated several times, for example, 2, 3, 4, or 5 times. During the wash act, the tissue sample may be retained in Chamber 2. For tissue samples comprising small chunks, Chamber 2 may comprise a mesh or a membrane filter to efficiently retain the sample. Multiple mesh and/or filter layers (Mesh 1 & Mesh 2) may be incorporated to provide desired tissue retention.

After washing, a dissociation solution may be added to Chamber 2 to dissociate the tissue sample and release the cells. The temperature of the chamber may be set at a certain optimized temperature using a heating, cooling, and/or temperature control system to facilitate sample dissociation. For example, the device may be placed in an incubator, a water bath, and/or in contact with a constant temperature plate to hold the temperature at about 37 degrees Celsius for optimum enzyme digestion. The dissociation solution may comprise one or more enzymes to break down connective matrices, extracellular matrices, etc. For example, collagenase may be used at 37 degrees Celsius to break down collagen fibers. Other reagents, including proteinase, protease, trypsin, proteinase K, lyase, enzymes, lysis solutions, hyaluronidase, lipase, trypsin, liberase, DNase, deoxyribonuclease, pepsin, or mixtures thereof may also be used for tissue digestion. Outlets (Connector 1 and/or Connector 2) at the dissociation chamber (Chamber 2) may be closed off during digestion. Chamber 2 may be massaged, squeezed gently, rocked, shaken, partially squeezed and released back and forth, or otherwise agitated to facilitate mixing and promote efficient tissue dissociation. When the digestion act is completed, Connector 2 may be opened to allow the released cells to exit the dissociation chamber. At least one mesh in Chamber 2 may serve to remove or retain large pieces of debris. One or more chase wash acts comprising adding a wash solution may be applied to rinse off potentially trapped cells in Chamber 2 after digestion.

The sample processing device shown in FIG. 3A may further comprise a debris removal chamber (Chamber 4), which may comprise a mesh, a membrane filter, and/or another debris removal mechanism (for example, Mesh 3). The dissociated sample may be transferred to the debris removal chamber, where large clumps, undesired cells, and/or debris may be removed from the sample. Chamber 4 may also serve as a sample storage chamber, where released cells are accommodated until further use. The released cells may be collected via Port 5. Chamber 4 may be an embodiment of the cell refinement device 530 shown schematically in FIG. 2E.

FIGS. 3B and 3C show an embodiment where a mesh is incorporated in Chamber 4. The mesh may be folded, sandwiched between two flexible sheets, and welded, glued, heat sealed, or otherwise fused together to form Chamber 4. Similarly, a mesh or a membrane filter may be incorporated in Chamber 2. FIGS. 3D and 3E include an exploded view and a cross-sectional view, respectively, of a portion of Chamber 2 showing that one or more meshes may be used in Chamber 2. Meshes included in Chamber 2 and/or Chamber 4 may comprise pores that get progressively smaller along a flow path of fluid through chambers 2 and/or 4. For example, the nominal pore size of Mesh 1 (FIG. 3D) may be from about 100 μm to about 900 μm, the nominal pore size of Mesh 2 may be from about 50 to about 200 μm, and the nominal pore size of Mesh 3 (FIG. 3C) may be from about 10 μm to about 60 μm.

It is appreciated that the present disclosure is not limited to the specific configuration of the embodiment shown in FIGS. 3A-3F. An embodiment of the present disclosure may comprise more or fewer chambers than those shown in FIGS. 3A-3F. Chambers having various functions may be employed and configured to achieve specific tasks comprising a specific sequence of acts. For example, the chambers may have functions including, but not limited to, sample collection, washing, rinsing, stratification, mixing, heating, cooling, filtering, digestion, storage, valving, volume measurement, pumping, fluid transfer and manipulation, cell labeling, sample treatment, dissociation, waste fluid collection, clump removal, debris removal, lysis, concentration, polymerase chain reaction (PCR), incubation, hybridization, cell culturing, cell expansion, etc.

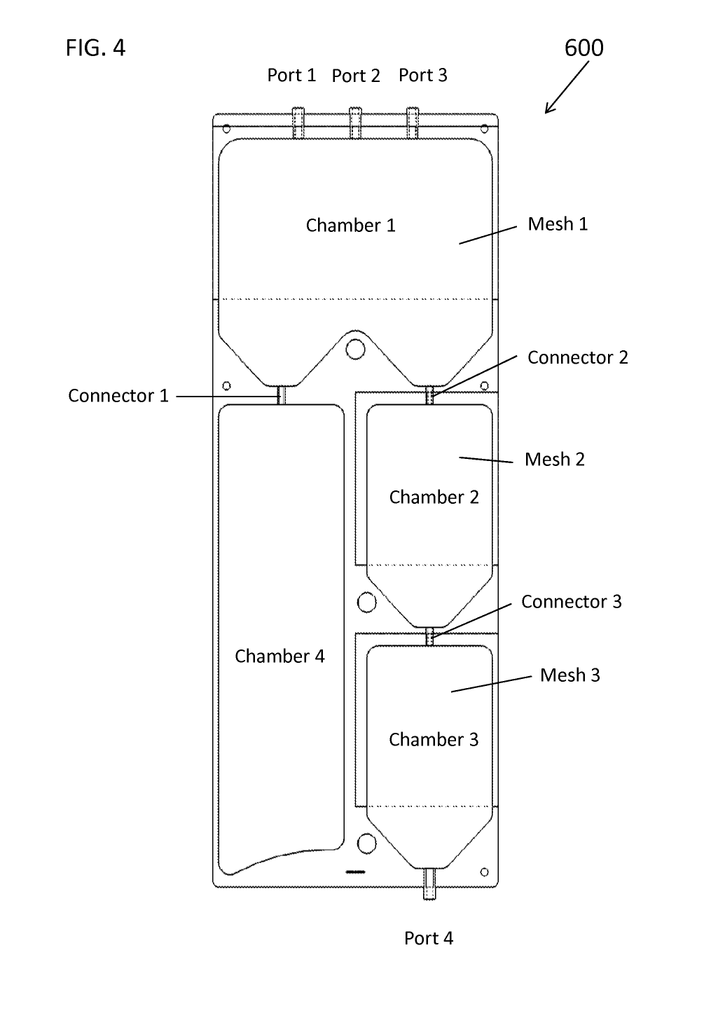

Another embodiment of a sample processing device of the present disclosure illustrated generally at 600 in FIG. 4 is formed using two plastic sheets. Chamber 1 is a sample washing and dissociation chamber, comprising three inlet ports (Port 1, Port 2, and Port 3), a mesh (Mesh 1), and two outlet connectors (Connector 1 and Connector 2). Chamber 2 is a clump reduction chamber comprising an inlet connector (Connector 2), an outlet/inlet connector (Connector 3), and a mesh (Mesh 2). Chamber 3, optionally comprising a mesh (Mesh 3), may be a reservoir for isolated cells and further debris removal or a cell refinement chamber. Chamber 4 is a waste solution collection chamber, comprising an inlet tubing (Connector 1) in fluid communication with an outlet connector of the sample washing and dissociation chamber (Chamber 1).

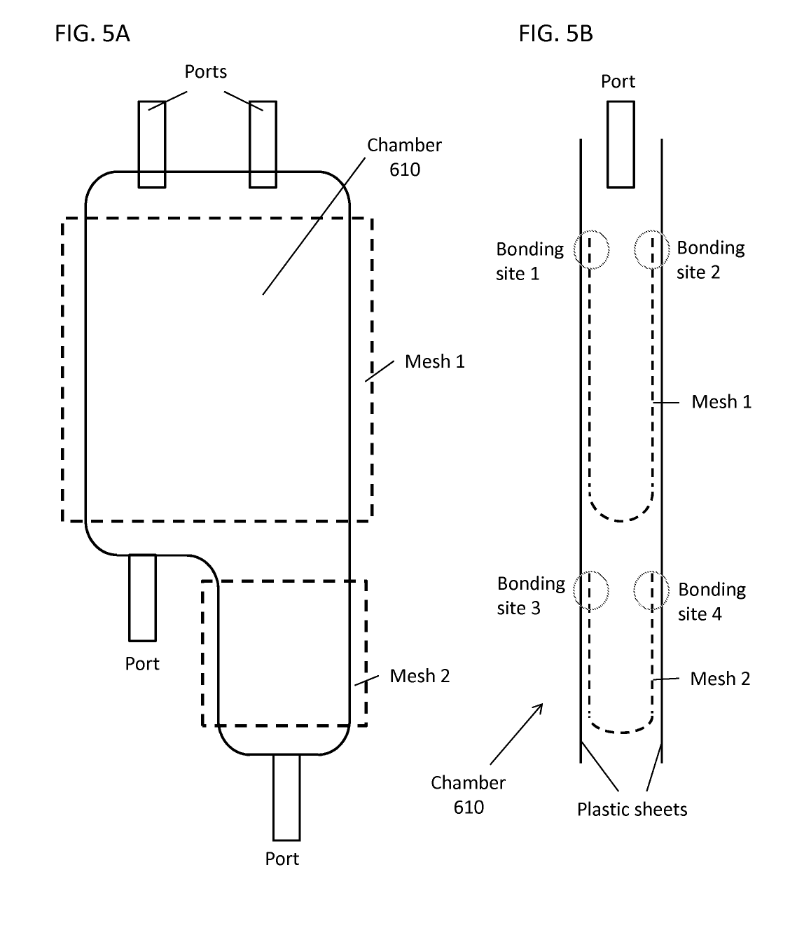

FIGS. 5A and 5B show another embodiment of a chamber 610 of the present disclosure, comprising two meshes. The two meshes are configured to not overlap substantially. Each mesh is folded and sandwiched between two flexible outer sheets. This embodiment may have the advantage of being easier to make, as only two layers of mesh have to be fused between the sheets.

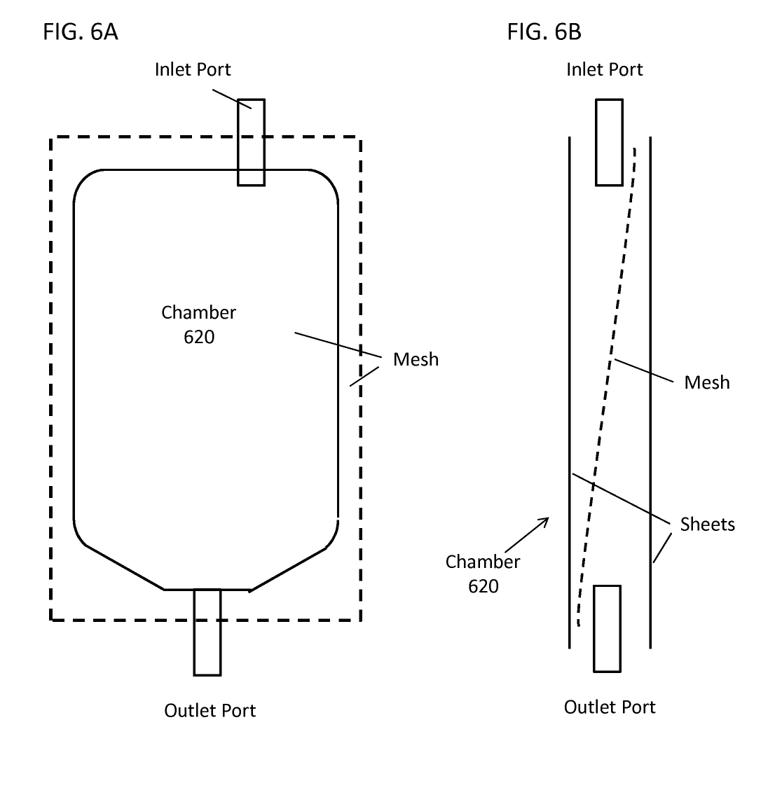

FIGS. 6A and 6B show yet another embodiment of a chamber 620 of the present disclosure, comprising at least one unfolded mesh sandwiched between two flexible outer sheets. The mesh is positioned between the inlet port and the outlet port, and is configured so that fluids entering from the inlet port have to pass through the mesh to get to the outlet port. The inlet port and the outlet port are on the opposite sides of the mesh. This configuration may have the advantage of being easy to make, as only one layer of mesh has to be sealed between the two sheets.

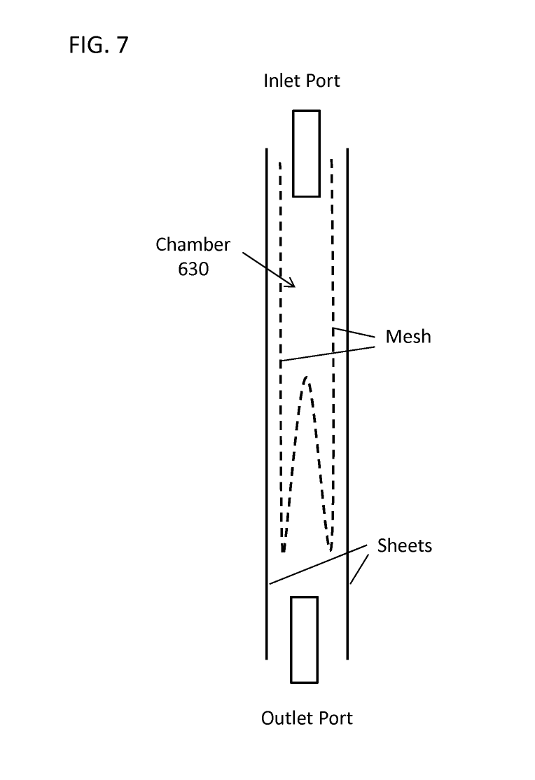

FIG. 7 shows yet another embodiment of a chamber 630 of the present disclosure, comprising a pleated mesh sandwiched between two flexible outer sheets. This configuration may have the advantage of increased mesh areas.

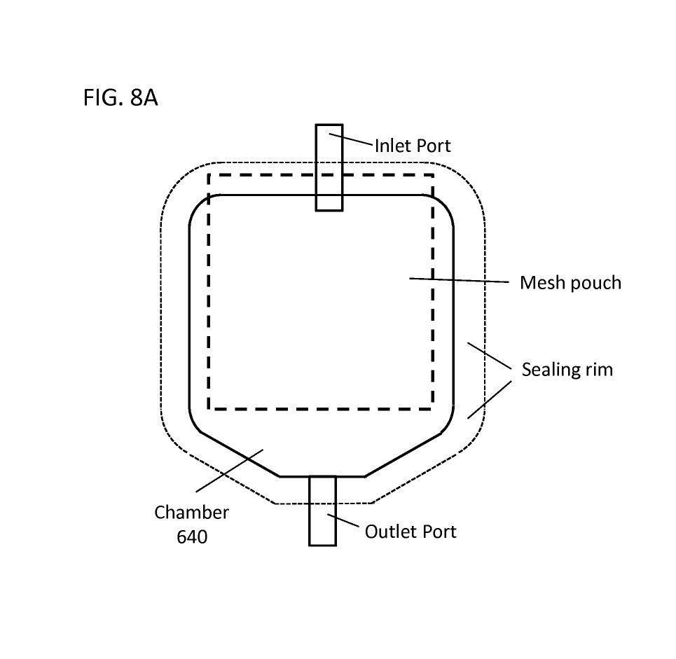

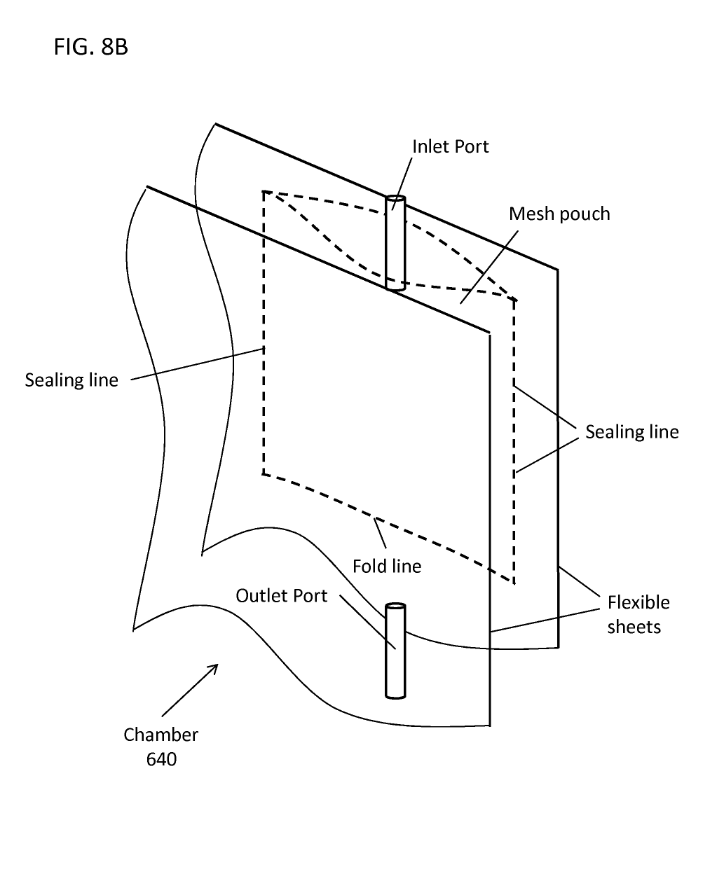

FIGS. 8A and 8B show yet another embodiment of a chamber 640 of the present disclosure, where the mesh is folded and sealed to form a pouch before being incorporated into a chamber. A piece of plastic mesh, for example, polyamide mesh, may be folded along a fold line and sealed along two sealing lines to form a mesh pouch using, for example, heat sealing or high frequency welding. The mesh pouch may then be positioned in between two flexible plastic sheets, for example, polyvinyl chloride (PVC) sheets, and sealed along the sealing rim using, for example, heat sealing or radio frequency welding to form a chamber.

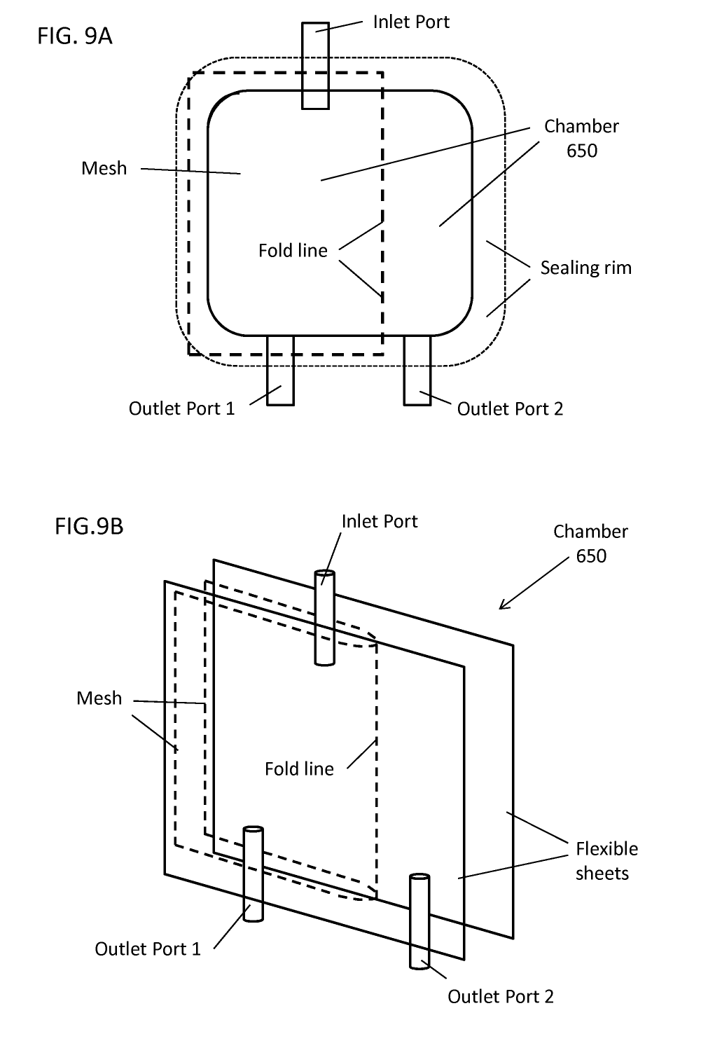

FIGS. 9A and 9B show yet another embodiment of a chamber 650 of the present disclosure, where the mesh is folded, sandwiched between two flexible plastic sheets and sealed into a chamber. Here the chamber and the mesh are configured so that a sample entering the chamber via the Inlet Port may exit via Outlet Port 1 without passing through the mesh, whereas the portion of sample exiting via Outlet Port 2 has to pass through the mesh. The fold line of the mesh is about vertical. In another embodiment, the fold line may be at an angle with respect to the vertical.

Any one or more of the mesh configurations illustrated in FIGS. 5A-9B may be utilized in any of the chambers of any of the sample processing devices disclosed herein, for example, in one or more of Chamber 2 or Chamber 4 of sample processing device 500 and/or one or more of Chamber 1, Chamber 2, and/or Chamber 3 of sample processing device 600.

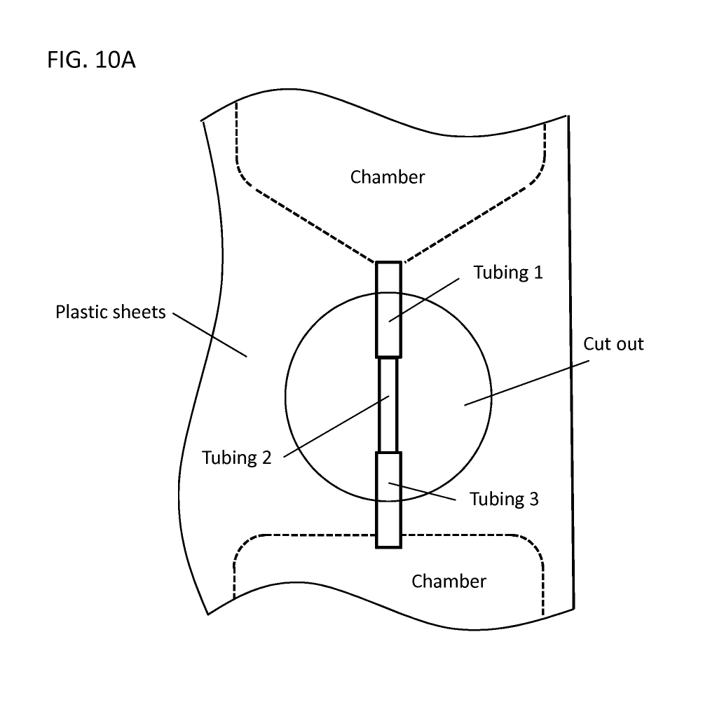

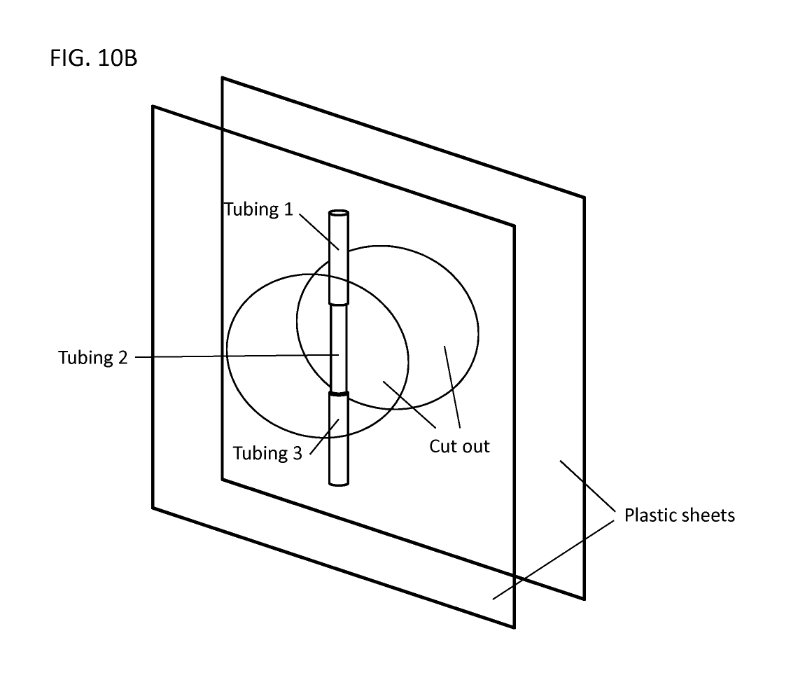

FIGS. 10A and 10B show a connector between two chambers comprising at least one tubing segment which may be included in any of the embodiments of the sample processing device disclosed herein. The plastic sheets are cutout and the tubing bridges from one chamber to the other chamber across the cutout. This configuration may allow valving means to access the tubing. For example, a pinch clamp or a slide clamp may be employed to turn the fluid connection on and off through the tubing. The tubing section may further comprise a soft and flexible stretch (Tubing 2 in FIGS. 10A and 10B) to facilitate reliable pinching. This may be advantageous when pinch valves are used. The pinch valves may be actuated manually, pneumatically, or with a solenoid. The flexible tubing may also facilitate peristaltic pumping when needed.

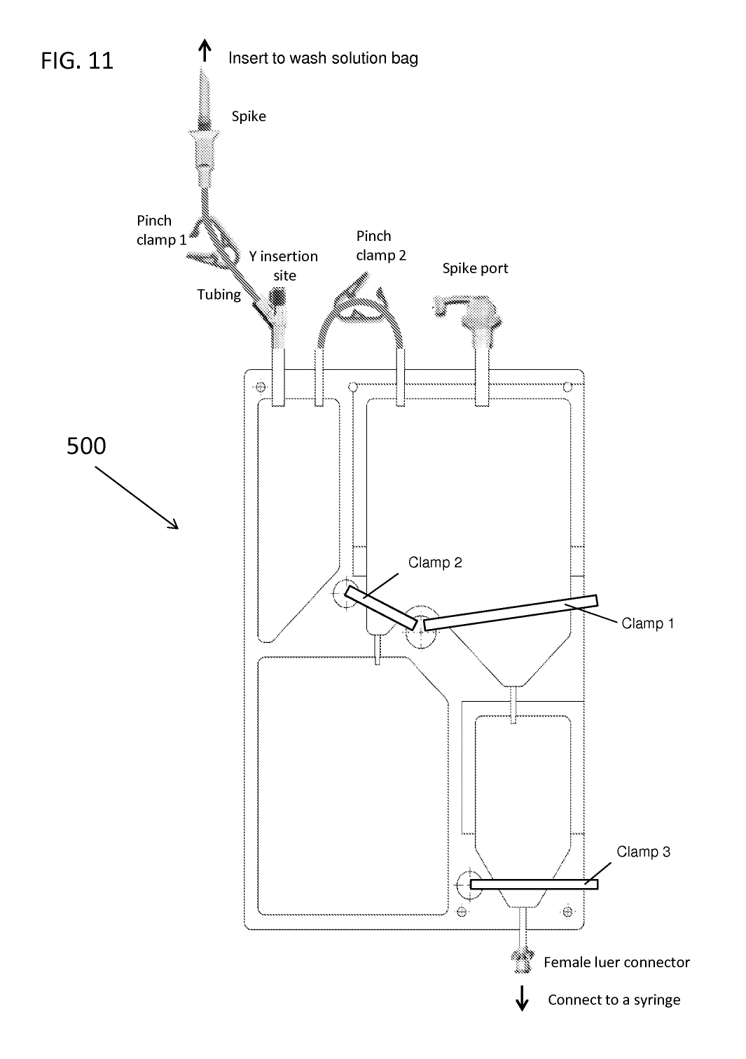

Embodiments of sample processing devices disclosed herein may further comprise other parts, such as those illustrated in FIG. 11 (for example, a spike that may be inserted into a wash solution bag, one or more pinch clamps, a Y insertion site, a spike port, and/or a luer connector for connection to a syringe), and/or may be connected to other modules as an integral part of a bigger system. Septums, injection ports, spike ports, valves, check valves, tubes, adaptors, luers, female luer locks, male luer locks, syringes, stopcocks, and/or other connection mechanisms may be employed to inter-connect parts of the embodiments of the present disclosure with other parts.

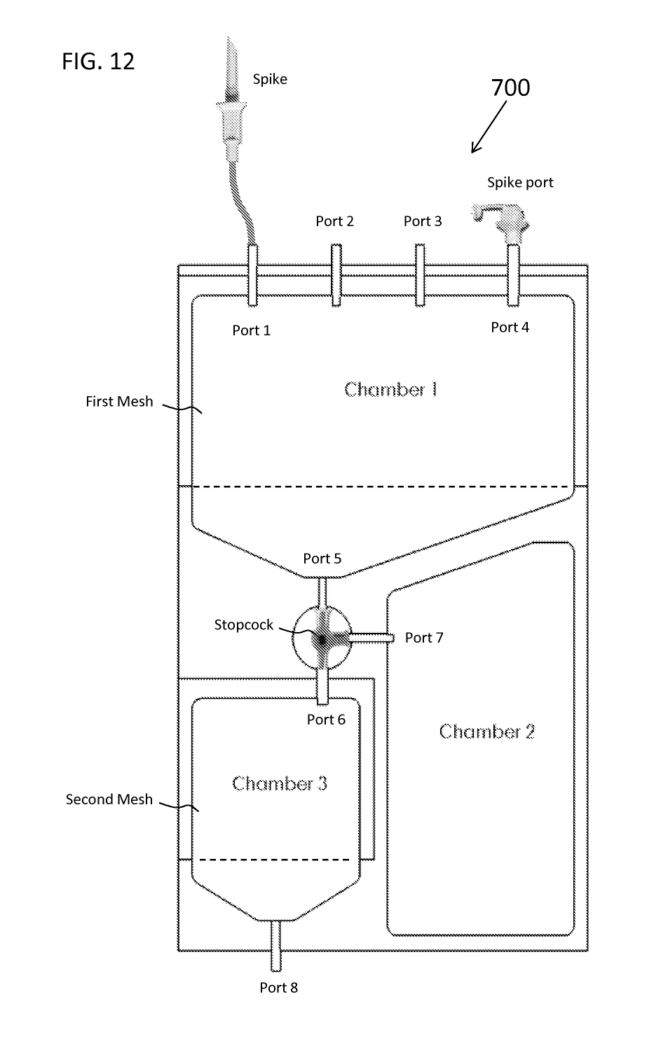

Another embodiment of the present disclosure is a sample preparation device comprising a sample dissociation chamber (Chamber 1), a waste container (Chamber 2) and a cell refinement chamber (Chamber 3), illustrated generally at 700 in FIG. 12. Chamber 1 may optionally comprise a first filter mesh to facilitate sample washing, rinsing and pre-conditioning. The mesh comprises pores having pore sizes of between about 20 μm and about 600 μm. For processing a lipoaspirate sample, the mesh may preferably have pore sizes of between about 40 μm and about 200 μm, for example, about 40 μm, about 50 μm, about 60 μm, about 70 μm, about 80 μm, about 90 μm, about 100 μm, about 120 μm, about 140 μm, about 170 μm, or about 200 μm. A stopcock controls the fluid connection at Port 5, which may be closed during sample dissociation and incubation, which may be connected to Chamber 2 via Port 7 during sample washing, and which may be connected to Chamber 3 via Port 6 for collecting released cells. Chamber 3 may comprise a second filter mesh having pore sizes of between about 15 μm and about 150 μm. If the released cells to be collected comprise bacteria, the second mesh may have pore sizes of between about 3 μm and about 20 μm, for example, about 3 μm, about 5 μm, about 7 μm, about 10 μm, about 12 μm, about 15 μm, about 17 μm, or about 20 μm. The second mesh removes debris from the dissociated sample and refines the released cells, which may be collected at Port 8. The device may further comprise an opening to receive a sample, for example, Port 4, which may comprise a spike port, an inlet to receive a rinsing solution, for example, Port 1, which may comprise a spike, and at least one inlet for receiving a dissociation solution, for example, Port 2.

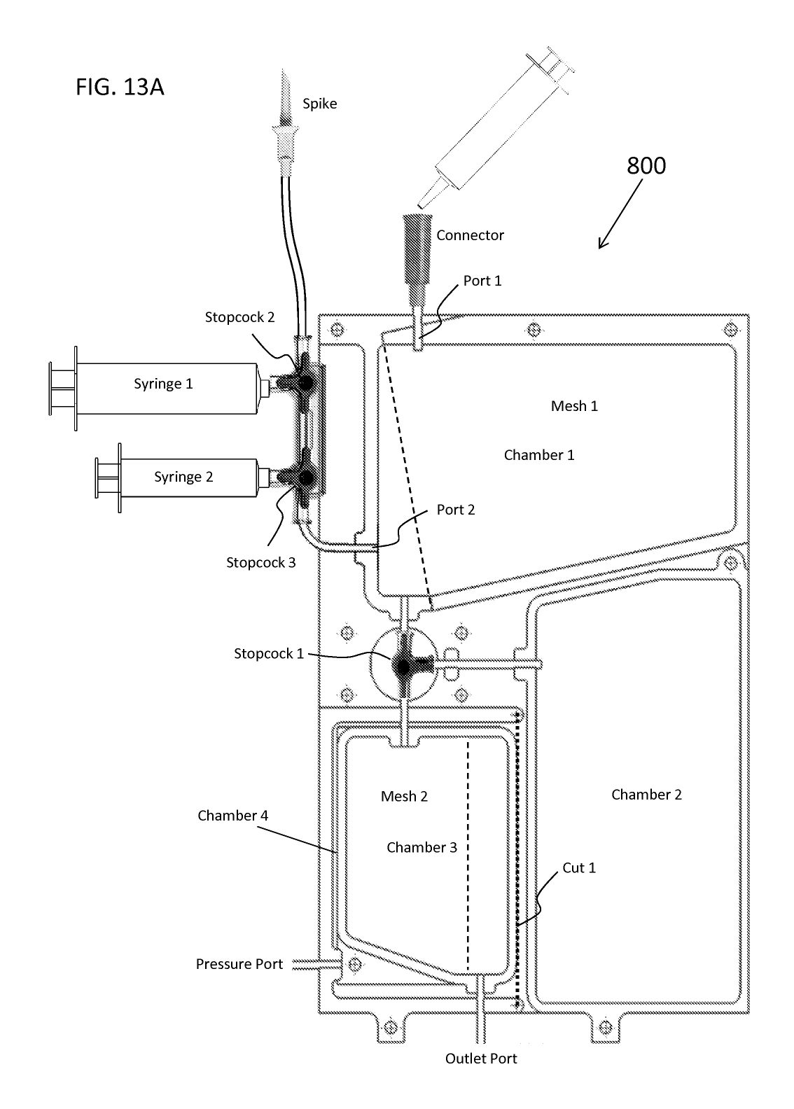

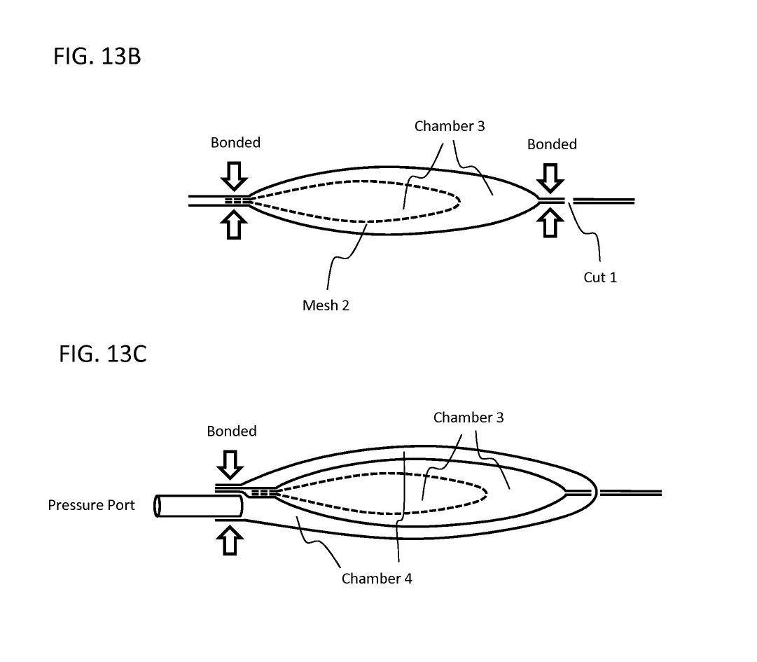

Yet another embodiment of the present disclosure is a sample preparation device comprising two flexible sheets of materials, for example, plastic, bonded together in predefined patterns to form a sample dissociation chamber (Chamber 1), a waste container (Chamber 2) and a cell refinement chamber (Chamber 3), illustrated generally at 800 in FIG. 13. Chamber 1 may comprise a first mesh (Mesh 1) to facilitate sample washing, rinsing and pre-conditioning. Chamber 3 may comprise a second mesh (Mesh 2) having pore sizes smaller than the pore sizes of the first mesh. Stopcock 1 controls the fluid connection between Chamber 1, Chamber 2, and Chamber 3. Chamber 1 comprises an inlet port (Port 1) comprising a connector which may facilitate receiving a sample from a syringe, for example, a syringe having a catheter tip. Chamber 1 further comprises another port (Port 2) connected to a stopcock manifold comprising Stopcock 2 and Stopcock 3. A rinsing solution, for example, lactated Ringer's injection solution, may be connected to the sample preparation device via a Spike. Syringe 1 and Stopcock 2 together may serve as a flow control device, which allows defined amounts of the rinsing solution to be added to Chamber 1. A dissociation solution may be loaded into Syringe 2 and added to the sample preparation device via Stopcock 3. The dissociation solution may be loaded into Syringe 2 in a concentrated form, and be re-constituted into a normal working concentration using the rinsing solution. Chamber 3 comprises an Outlet Port, where released cells may be collected. In some embodiments, it is desirable to increase the pressure at the Outlet Port. Chamber 3 may be enclosed in a pressurizing chamber (Chamber 4) in an air tight manner. Chamber 4 comprises a Pressure Port where a pressurized fluid, for example, compressed air, may be applied to indirectly pressurize the fluids in Chamber 3 through the flexible sheets of Chamber 3. An embodiment of Chamber 3 is illustrated in FIG. 13B and an embodiment of the pressurizing chamber including Chamber 4 is shown in FIG. 13C. Chamber 3 is formed by bonding two flexible sheets together at pre-defined locations (FIG. 13B). A cut (Cut 1) is made in the sheets to allow another sheet to enclose Chamber 3 and form Chamber 4.

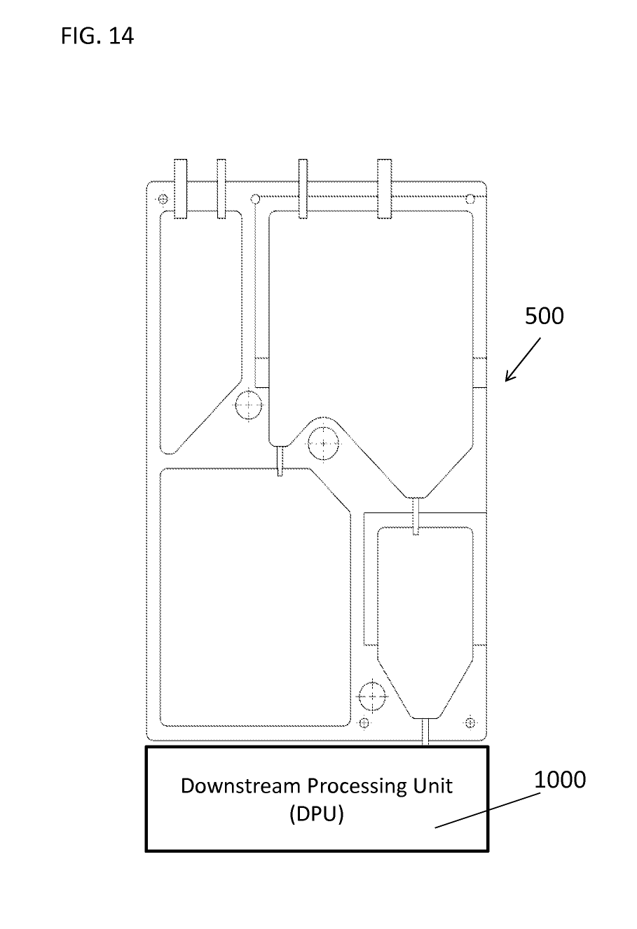

Another embodiment of the present disclosure comprises a downstream processing unit (DPU 1000 illustrated in FIG. 14), which may further process, refine, culture, expand and/or analyze the processed biological tissue and/or isolated cells. The downstream processing unit may be configured to facilitate, for example, one or more of the following functions: sample washing, sample concentration, sample separation, sample enrichment, sample isolation, buffer exchange, sample labeling, sample alteration, filtration, magnetic labeling, magnetic separation, polymerase chain reaction (PCR), antibody interaction, affinity capturing using antibodies, imaging of cells, enzyme-linked immunosorbent assay (ELISA), protein preparation, protein purification, protein enrichment, mass spectrometry, high-performance liquid chromatography, flow cytometry, cell sorting, functional assays, cell culture, cell expansion, cell differentiation, immunophenotyping, lateral flow assay, fluorescent in situ hybridization, deoxyribonucleic acid (DNA) hybridization, ribonucleic acid (RNA) hybridization, deoxyribonucleic acid (DNA) reaction, ribonucleic acid (RNA) reaction, etc.

The downstream processing unit may comprise a microfluidic unit comprising at least one microfluidic device. The microfluidic device may comprise at least one channel dimension smaller than about 1 mm, for example, about 0.95 mm, about 800 μm, about 600 μm, about 500 μm, about 400 μm, about 300 μm, about 200 μm, about 150 μm, about 100 μm, about 80 μm, about 60 μm, about 50 μm, about 40 μm, about 30 μm, about 20 μm, and/or about 15 μm. The microfluidic device may also comprise channels of at least one substantially constant depth. For example, the microfluidic device may comprise channels having a depth of about 1 mm, about 800 μm, about 600 μm, about 500 μm, about 400 μm, about 300 μm, about 200 μm, about 150 μm, about 100 μm, about 80 μm, about 60 μm, about 50 μm, about 40 μm, about 30 μm, about 20 μm, or about 15 μm. The channel depths of the microfluidic device may be within 20% of a nominal channel depth. The microfluidic device may further comprise channels substantially on one surface, which may be substantially planar or curved. The microfluidic device may also comprise channels formed on one or more substantially planar surfaces.

The microfluidic device may be formed using microfabrication, nanofabrication, and/or micromachining techniques, including but not limited to photolithography, etching, reactive ion etching, deep reactive ion etching, wet etching, imprinting, injection molding, embossing, soft embossing, stereo lithography, molding, soft lithography, anodic bonding, ultrasound bonding, self assembling, and/or other fabrication techniques known in the art.

Embodiments of microfluidic units of the current disclosure may include devices disclosed in International Application PCT/US10/061866, International Publication WO 2011/079217 A1, U.S. Pat. No. 7,150,812 B2, U.S. Pat. No. 7,735,652, U.S. Pat. No. 8,021,614, U.S. Pat. No. 8,186,913 B2, United States Patent Application Publication No. US 2012/0063664 A1, United States Patent Application Publication No. US 2011/0294187 A1, which are herein incorporated by reference in their entireties for all purposes, devices employing Dean flows, inertial forces, centrifugal forces, deterministic lateral displacements, arrays of pillars, arrays of posts, pinch flows, magnetic structures, antibody components, cell capture moieties, protein capture moieties, deoxyribonucleic acid (DNA) moieties, ribonucleic acid (RNA) moieties, filtration, tangential flow filtration, ultrasound focusing, pinch flow, etc.

It is worth noting that some embodiments of the present disclosure, particularly those incorporating microfluidic devices disclosed in International Publication WO 2011/079217 A1, provide devices resistant to serious clogging and fouling, which until now have been a serious problem prohibiting the use of microfluidic devices for tangential flow filtration of digested fat tissue.

Another embodiment of the present disclosure comprises a hollow fiber unit to concentrate and/or wash the isolated cells.

In another embodiment of the downstream processing unit comprising a microfluidic device, the microfluidic device washes the cells and removes unwanted reagents. The downstream processing unit may comprise a buffer solution inlet to introduce a buffer solution to wash the cells. Cell wash may also be achieved using a microfluidic device designed to perform dialysis.

In yet another embodiment of the present disclosure, a downstream processing unit comprises a microfluidic device that reduces the enzyme concentration in the output of the downstream processing unit by a factor of greater than about 10, for example, the enzyme concentration is reduced by a factor of about 10, about 20, about 30, about 40, about 50, about 70, about 100, about 150, about 200, about 400, about 500, about 750, about 1,000, about 2,000, about 5,000, about 10,000, about 20,000, about 50,000, about 100,000, about 200,000, about 500,000, or about 1,000,000. One embodiment of the microfluidic device that may achieve such enzyme removal is disclosed in International Publication WO 2011/079217 A1, where the microfluidic device comprises pillars and employs at least one buffer stream, e.g. a stream of rinsing solutions, to wash cells.

In yet another embodiment of the present disclosure, a downstream processing unit comprises a microfluidic device that removes greater than 89% of the enzymes introduced during sample dissociation, for example, about 90%, about 95%, about 97%, about 98%, about 99%, about 99.5%, about 99.8%, about 99.9%, about 99.95%, about 99.98%, about 99.99%, about 99.995%, about 99.998%, about 99.999%, about 99.9995%, or about 99.9999% of the enzymes introduced during sample dissociation are removed.

In yet another embodiment of the present disclosure, a downstream processing unit comprises a microfluidic device that removes about 100% of the enzymes introduced during sample dissociation.

In yet another embodiment of the present disclosure, a downstream processing unit comprises a microfluidic device that provides an output having a collagenase concentration of less than about 0.1 mg/ml, for example, about 0.09 mg/ml, about 0.05 mg/ml, about 0.03 mg/ml, about 0.02 mg/ml, about 0.01 mg/ml, about 0.007 mg/ml, about 0.005 mg/ml, about 0.003 mg/ml, about 0.002 mg/ml, about 0.001 mg/ml, about 0.0005 mg/ml, about 0.0002 mg/ml, about 0.0001 mg/ml, about 0.00005 mg/ml, about 0.00002 mg/ml, about 0.00001 mg/ml, about 0.000001 mg/ml, or about 0.0000001 mg/ml.

In yet another embodiment of the present disclosure, a downstream processing unit comprises a microfluidic device that provides an output essentially free of enzymes introduced during sample dissociation. In yet another embodiment of the present disclosure, a downstream processing unit comprises a microfluidic device that provides an output free of enzymes introduced during sample dissociation.

In yet another embodiment of the present disclosure, a downstream processing unit comprises a microfluidic device that provides an output essentially free of collagenase introduced during sample dissociation. In yet another embodiment of the present disclosure, a downstream processing unit comprises a microfluidic device that provides an output free of collagenase introduced during sample dissociation.

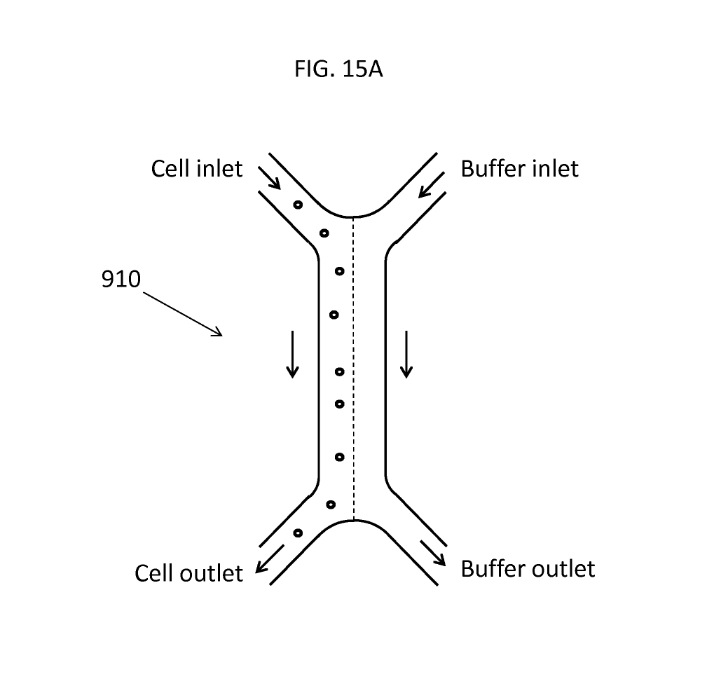

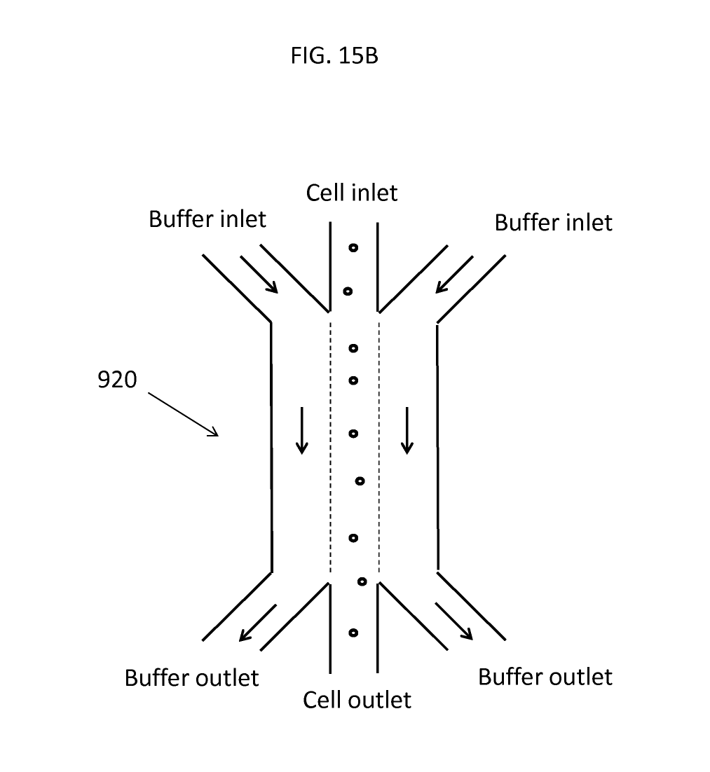

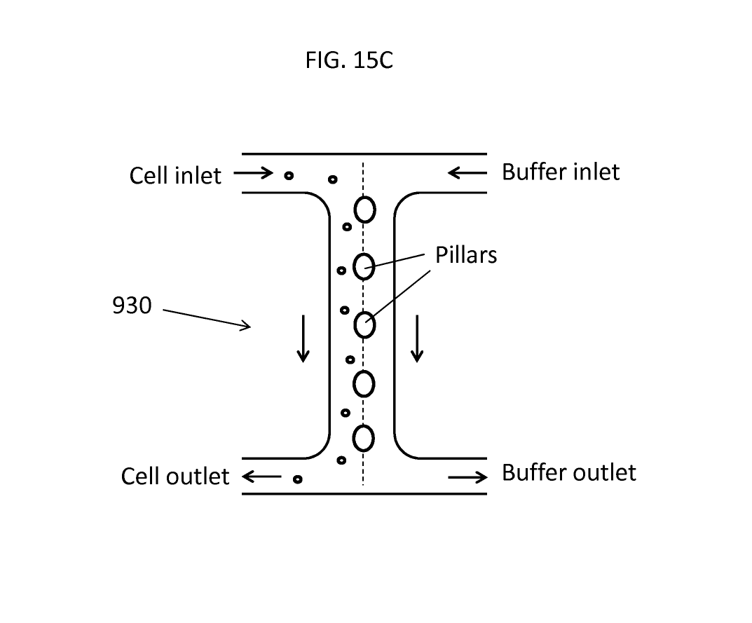

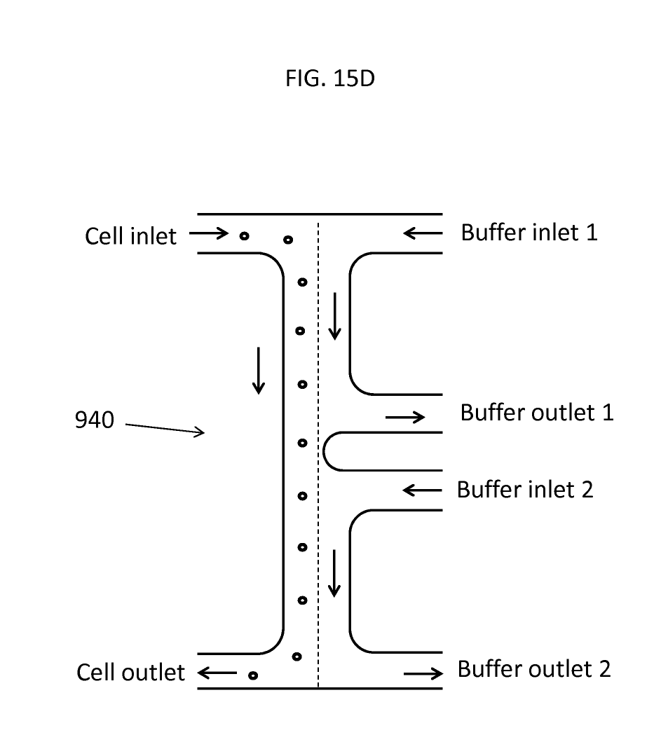

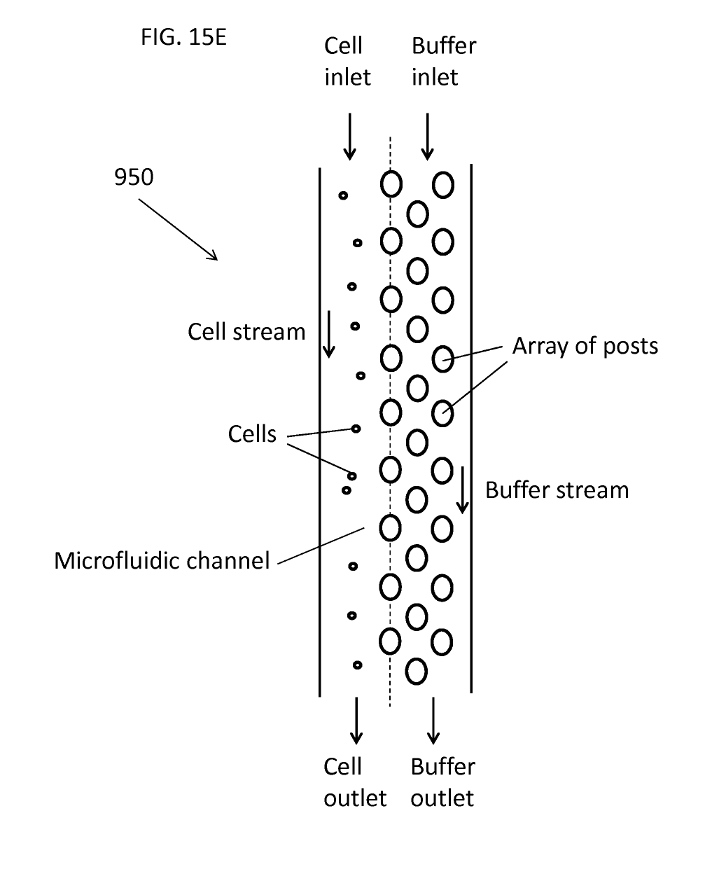

Examples of microfluidic devices which may be used in any one or more of the sample processing devices disclosed herein are schematically illustrated in FIGS. 15A, 15B, 15C, 15D, and 15E indicated generally at 910, 920, 930, 940, and 950, respectively.

FIG. 15A shows a microfluidic channel 910 with a cell inlet, a buffer inlet, a cell outlet and a buffer outlet. The microfluidic channel has a width and/or a depth so small, for example, about 100 μm, that the cell sample and buffer form two laminar flow streams flowing side by side with each other without substantial convective mixing. The flow speed is configured to give undesired particles, for example, enzymes, enough time to diffuse from the cell flow stream to the buffer flow stream. Because cells are much larger than the undesired particles, their diffusion is so small that they remain in the cell flow stream. The cell stream and the buffer stream exit the microfluidic channel via different exits, thereby substantially removing the undesired particles.

FIG. 15B shows another microfluidic channel 920 with a cell inlet, two buffer inlets, a cell outlet and two buffer outlets. The channels and flow speeds are configured to allow undesired particles to diffuse from the cell stream to the buffer streams, thereby substantially removing the undesired particles. This configuration may have high removal efficiencies because the undesired particles may be removed by two buffer streams.

Posts or pillars may be positioned in the microfluidic channels, for example, as illustrated in microfluidic channel 930 illustrated in FIG. 15C, to stabilize the cell and buffer streams, promote molecular diffusion, and/or support the microfluidic channel.

Microfluidic devices utilized for dialysis may be configured in series to form a cascade. An example is shown in FIG. 15D, where buffer solutions carrying undesired particles are removed from Buffer Outlet 1 and fresh buffer solutions may be introduced via Buffer Inlet 2 to substantially remove residual undesired particles.

FIG. 15E shows another embodiment of a microfluidic device 950 comprising a channel and an array of posts in the channel. The flow speed of fluids introduced to the channel and the channel dimensions are designed so that the fluid streams are laminar. Typically the laminar flow and laminar fluid streams occur when the Reynolds number of fluids in the microfluidic device is smaller than about 1. The array of posts increases the effective diffusion coefficient of particles in the buffer stream, and improves the efficiency of removing un-wanted particles, for example, enzymes from the cell stream.

In some embodiments, the buffer used to form the buffer stream in a microfluidic device is a rinsing solution.

In yet another embodiment, the downstream processing unit comprises a dialysis membrane.

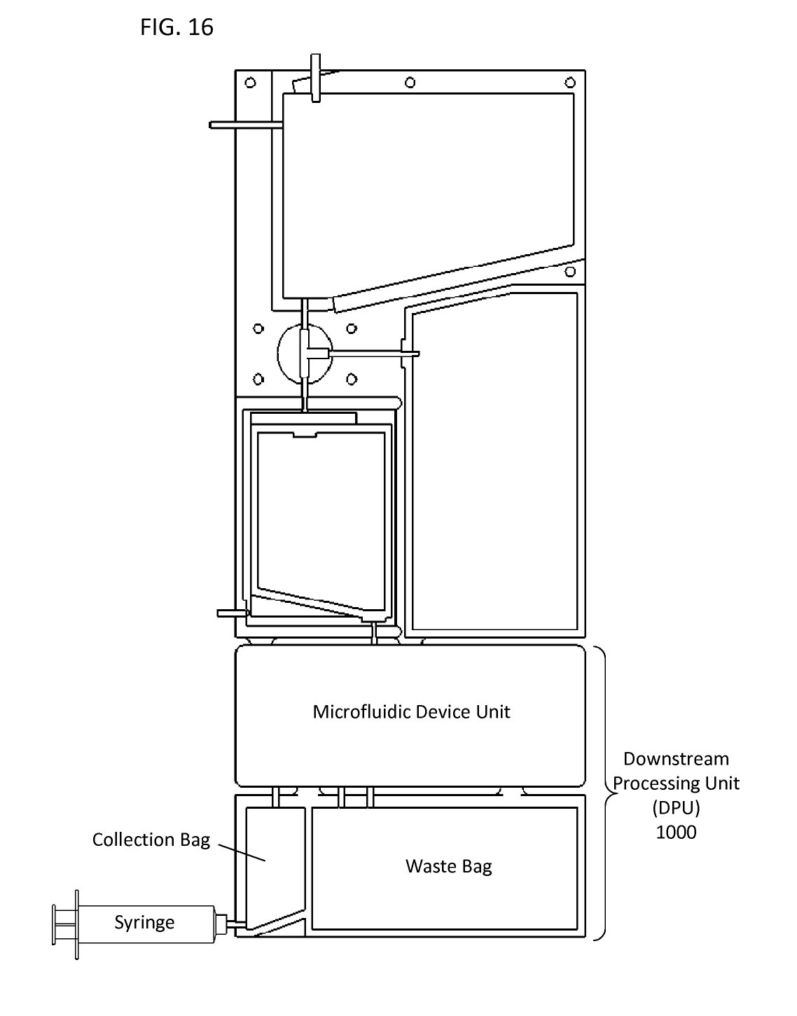

Yet another embodiment of the downstream processing unit 1000, schematically shown in FIG. 16, comprises a microfluidic device unit comprising at least one microfluidic device which concentrates the isolated cells, and at least one collection reservoir, for example, a collection bag, configured to receive the isolated cells as an output of the microfluidic device. The downstream processing unit may further comprise a syringe connected to the said collection reservoir. The output may be drawn into the syringe from the collection reservoir after the sample has been processed using the microfluidic device. The downstream processing unit may further comprise a waste reservoir, for example, a waste bag.

In another embodiment of the present disclosure, the downstream processing unit comprises multiple microfluidic devices to achieve the desired capacity, throughput, and functions for processing large volumes of output sample.

The transfer of fluids may be achieved using gravity, an external pressure, a vacuum, a positive pressure, a negative pressure, a head height, a pump, for example, a peristaltic pump, a mechanism configured to squeeze the bag, a roller that squeezes the bag, a plate that squeezes the bag, and/or other fluid transfer mechanisms known in the art. In one embodiment fluids may be transferred using a syringe. In another embodiment fluids may be transferred using an external air pressure applied to a chamber, for example Chamber 4 enclosing a bag (Chamber 3) containing cells, as shown in FIG. 13.

In another embodiment of the present disclosure, the downstream processing unit comprises a cell culture chamber for culturing cells. The cell culture chamber may be connected using a connector, which allows the cell culture chamber to be detached. The cell culture chamber may be placed in an incubator, where the temperature and conditions for cell growth may be optimized, for example, at a temperature of about 37 degrees Celsius and about 5% carbon dioxide concentration. The cell culture chamber may further comprise materials permeable to air, for example, a filter membrane or silicone rubber film, allowing gas exchange during cell culture.

One or more chambers of sample processing devices as disclosed herein may comprise a mesh, multiple layers of mesh, and or a cascade of meshes (FIG. 5B). In some embodiments, the pore sizes (for example, the median or average sizes of openings of the pores) of meshes used for tissue processing may be between about 1 μm and about 10 mm, for example, about 1 μm, about 3 μm, about 6 μm, about 10 μm, about 15 μm, about 25 μm, about 40 μm, about 70 μm, about 100 μm, about 140 μm, about 300 μm, about 700 μm, about 1 mm, about 2 mm, or about 3 mm. For isolating non-fat cells from lipoaspirate tissues, a mesh pore size may be between about 10 μm and about 2 mm. In some embodiments, about 40 μm, about 70 μm, about 100 μm, about 140 μm, about 250 μm, and/or about 700 μm pore size meshes, for example, polyamide (Nylon) meshes, may be employed.

Another embodiment of a sample processing device of the present disclosure comprises one or more chambers including two meshes, a second mesh in fluid communication downstream of a first mesh, where the pores of the second mesh are substantially smaller than the pores of the first mesh.

Yet another embodiment of a sample processing device of the present disclosure comprises one or more chambers including two membrane filters. A second of the membrane filters may be in fluid communication downstream of a first of the membrane filters. The pores of the second membrane filter may be substantially smaller than the pores of the first membrane filter.

Yet another embodiment of a sample processing device of the present disclosure comprises one or more chambers including a track-etched membrane filters.

Embodiments of sample processing devices or subcomponents thereof as disclosed herein may be constructed using materials including but not limited to thermoplastics, acrylonitrile butadiene styrene (ABS), acrylic (PMMA), celluloid, cellulose acetate, cyclic olefin copolymer (COC), cyclic olefin copolymer (COP), ethylene-vinyl acetate (EVA), ethylene vinyl alcohol (EVOH), fluoroplastics (PTFE, alongside with FEP, PFA, CTFE, ECTFE, ETFE), ionomers, liquid crystal polymer (LCP), polyoxymethylene (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone, polyester, polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polytrimethylene terephthalate (PTT), polyurethane (PU), polyvinyl acetate (PVA), polyvinyl chloride (PVC), polyvinylidene chloride (PVDC), styrene-acrylonitrile (SAN), and/or acrylonitrile butadiene styrene (ABS). For medical applications, flexible plastic sheets such as polyvinyl chloride (PVC), polyurethane (PU), ethylene-vinyl acetate (EVA), polyamide (PA or Nylon) may be used as the sheet material. In some embodiments a sample processing device as disclosed herein may comprise two flexible sheets bonded together and defining one or more chambers therebetween. In other embodiments a sample processing device as disclosed herein may comprise a flexible sheet bonded to a rigid or semi-rigid material (for example, a thick sheet of plastic and/or any one or more of the materials disclosed above) and defining one or more chambers between the flexible sheet and the rigid or semi-rigid material.

The thickness of the sheet material may be, in some embodiments, between about 0.1 mm and about 0.8 mm, for example, about 0.1 mm, about 0.15 mm, about 0.2 mm, about 0.25 mm, about 0.3 mm, about 0.35 mm, about 0.4 mm, about 0.5 mm, about 0.6 mm, about 0.7 mm, or about 0.8 mm. The thickness of the sheet material may be, in other embodiments, between about 0.2 mm and about 0.4 mm, for example, about 0.2 mm, about 0.25 mm, about 0.3 mm, about 0.35 mm, or about 0.4 mm.

Materials for membrane filters and/or meshes may include, but are not limited to cellulose acetate (CA), glass microfibre (GMF), polyethersulphone (PES), polypropylene (PP), regenerated cellulose (RC), polyamide (PA or Nylon), polytetrafluoroethylene (PTFE), and/or polyvinylidene fluoride (PVDF).

The thickness of the mesh material may be, in some embodiments, between about 10 μm and about 1,000 μm, for example, about 10 μm, about 15 μm, about 20 μm, about 25 μm, about 30 μm, about 40 μm, about 50 μm, about 60 μm, about 70 μm, about 80 μm, about 90 μm, about 100 μm, about 120 μm, about 150 μm, about 175 μm, about 200 μm, about 250 μm, about 300 μm, about 400 μm, about 500 μm, about 600 μm, about 700 μm, about 800 μm, about 900 μm or about 1 mm. The thickness of the mesh material may be, in other embodiments, between about 50 μm and about 300 μm, for example, about 50 μm, about 60 μm, about 70 μm, about 80 μm, about 90 μm, about 100 μm, about 110 μm, about 125 μm, about 140 μm, about 160 μm, about 180 μm, about 200 μm, about 220 μm, about 250 μm, about 275 μm, or about 300 μm.

Embodiments of the present disclosure may be constructed using standard plastic manufacturing techniques, including, but not limited to plastic welding, heat sealing, injection molding, embossing, glue bonding, ultraviolet light (UV) cured adhesive bonding, solvent bonding, hot gas welding, freehand welding, speed tip welding, extrusion welding, contact welding, hot plate welding, high frequency welding, radio frequency welding, injection welding, ultrasonic welding, friction welding, spin welding, laser welding, and/or solvent welding.

Embodiments of the present disclosure, for example, the sample processing device shown schematically in any of FIGS. 2A-2G, may be constructed using high frequency welding of thermoplastic sheets. Welding die may be made of metals, for example, aluminum, brass or stainless steel. Mesh pieces, which may be folded, and tubing pieces are placed between the two thermoplastic sheets on a welding die. The thermoplastic sheets are then sandwiched using another welding die. Chambers are formed when a pressure, a temperature and a radio frequency electrical power is applied to the welding dies. For sealing polyvinyl chloride (PVC) sheets with polyamide meshes, a temperature of between about 25 degrees Celsius and about 120 degrees Celsius, for example, about 25 degrees Celsius, about 50 degrees Celsius, about 60 degrees Celsius, about 70 degrees Celsius, about 80 degrees Celsius, about 90 degrees Celsius, about 100 degrees Celsius, about 110 degrees Celsius, or about 120 degrees Celsius, a pressure of between about 10 psi and about 600 psi, for example, about 10 psi, about 20 psi, about 30 psi, about 40 psi, about 50 psi, about 60 psi, about 80 psi, about 100 psi, about 150 psi, about 200 psi, about 300 psi, about 400 psi, about 500 psi, or about 600 psi, and a radio frequency power of between about 300 W and 10 kW, for example, about 300 W, about 500 W, about 600 W, about 700 W, about 800 W, about 900 W, about 1 kW, about 1.2 kW, about 1.5 kW, about 2 kW, about 2.5 kW, about 3 kW, about 4 kW, about 5 kW, about 6 kW, about 7 kW, about 8 kW, about 9 kW, or about 10 kW, may be applied. The radio frequency power may be applied for a duration of between about 0.5 seconds and about 1 minute, for example, about 0.5 seconds, about 1 second, about 2 second, about 3 second, about 4 second, about 5 second, about 6 second, about 7 second, about 8 second, about 10 seconds, about 12 seconds, about 15 seconds, about 20 seconds, about 30 seconds, about 40 seconds, about 50 seconds, and about 60 seconds. The radio frequency power may be applied several times at equal or different intensities to form a reliable seal. For medical applications, the devices may be manufactured in a controlled clean environment and sterilized using standard sterilization techniques, including, but not limited to gamma irradiation, ethylene oxide (EO) sterilization, and ultraviolet light (UV) irradiation.

In some embodiments of the present disclosure the sample preparation device is sterile. In some embodiments of the present disclosure the sample preparation device is single-use. Further, in some embodiments of the present disclosure the sample preparation device is a substantial protective barrier providing an isolated environment, where samples are protected from direct physical contact, or fluid contact, for example, through unfiltered air flow, with the external environment and/or operating personnel to minimize or avoid contamination and infection risks.

It is appreciated that embodiments of the present disclosure may serve as a protective barrier that substantially reduces or eliminates any direct physical contact, fluid connection, and/or air flow connection between a tissue sample and the ambient environment. Any part of embodiments of the devices disclosed herein that may be in direct physical contact, fluid connection, and/or unfiltered air flow connection with the sample may be sterile and/or single use. It is appreciated that embodiments of the devices disclosed herein may substantially protect a sample from contamination risks and operators from infection risks.

It is appreciated that the present disclosure enables the design of tissue processing devices that are very easy to use. It is also appreciated that present disclosure may drastically simplify the manufacturing process and reduce the manufacturing cost of such tissue processing devices. It is further appreciated that the embodiments of the present disclosure enables a tissue sample to be processed safely substantially free of contamination and infection risks using a device that substantially isolates the sample from the surrounding laboratory or hospital environment.

### Examples

### Example 1

### Isolation of Non-Fat Cells from Human Lipoaspirate Tissues

Human lipoaspirate was processed using a method comprising the acts depicted in FIG. 1 and a device as shown in FIGS. 3A and 11. The device is about 25 cm wide and about 40 cm long. The flexible plastic sheets are made of polyvinyl chloride (PVC) and the meshes are made of polyamide (nylon). The meshes 1, 2, and 3 have nominal pore sizes of about 140 μm, about 70 μm, and about 35 μm, respectively. About 40 ml of human lipoaspirate was collected from a consented donor using tumescent liposuction and processed within 24 hours from collection. The sample was shipped and stored at 4 degrees Celsius before processing.

Initially, Clamps 1 and 2 were applied to close off Connectors 1 and 2 (FIG. 3F). About 100 ml of lipoaspirate was added to the device via a spike port (FIG. 11). Clamp 2 was opened to allow excess fluids comprising blood and tumescent solutions to drain off to Chamber 3 under gravity. After the excess fluids were substantially removed, Clamp 2 was closed and Pinch Clamp 1 was opened to allow about 50 ml of lactated Ringers solution to enter the measuring chamber (Chamber 1). Pinch Clamp 1 was closed and Pinch Clamp 2 was opened. Chamber 1 was squeezed using two flat plates to transfer the lactated Ringers solution to Chamber 2. This fluid measuring and transfer process was repeated until about 100 ml of lactated Ringers solution was added to Chamber 2. The lactated Ringers solution and the lipoaspirate sample were mixed using gentle massage of Chamber 2 to wash the sample. Clamp 2 was opened to allow the waste fluid to drain. This wash act here was performed three times.

The tissue dissociation act started with closing Clamps 1 and 2 and adding a dissociation solution into Chamber 1 from the Y insertion site (FIG. 11). The dissociation solution comprised 200 mg of collagenase and 50 mg of DNase I, dissolved in 20 ml of lactated Ringers solution. More lactated Ringers solution was introduced to Chamber 1 to dilute the dissociation solution. The dissociation solution was then transferred to Chamber 2. The lactated Ringers solution was introduced to Chamber 1 again to wash Chamber 1 and transfer residual dissociation solution to Chamber 2. About 100 ml of lactated Ringers solution was added to Chamber 2 during the tissue dissociation act. The device was placed in a 37 degree Celsius incubator and massaged frequently to effectively mix the tissue sample with the dissociation solution. The tissue dissociation act took about 45 minutes to 60 minutes.

After dissociation, Clamp 1 was open to allow released cells to enter a debris removal chamber (Chamber 4 in FIG. 3A). Clamp 2 was subsequently opened to allow the sample to pass through Mesh 3. Tissue debris and fat cells were substantially removed during this act.

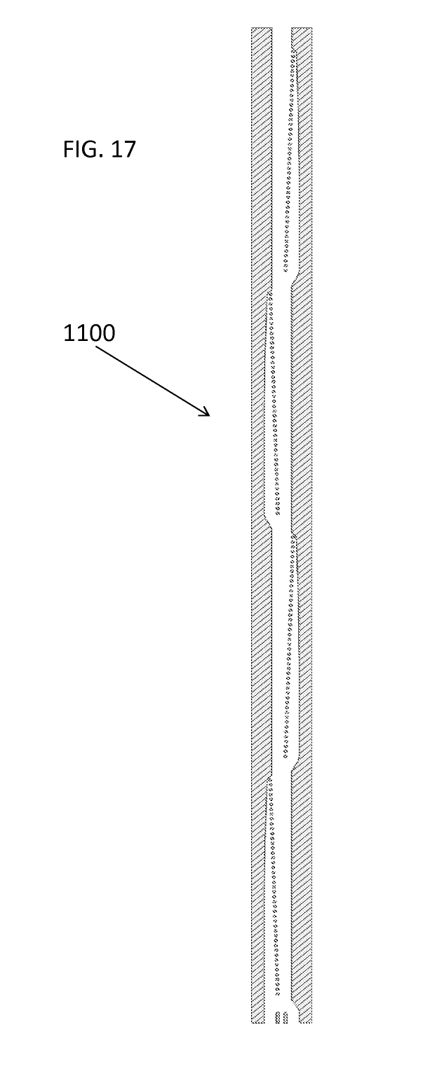

The solution coming out of Chamber 4 was then fed under gravity into a microfluidic device 1100, illustrated in FIG. 17 and disclosed in International Application PCT/US10/061866, which is herein incorporated by reference in its entirety for all purposes. The microfluidic device comprised about 110 modules arranged on a flat surface of a substrate. Each module comprised about 900 pillars configured into four rows. The depth of the microfluidic channels was about 30 μm.

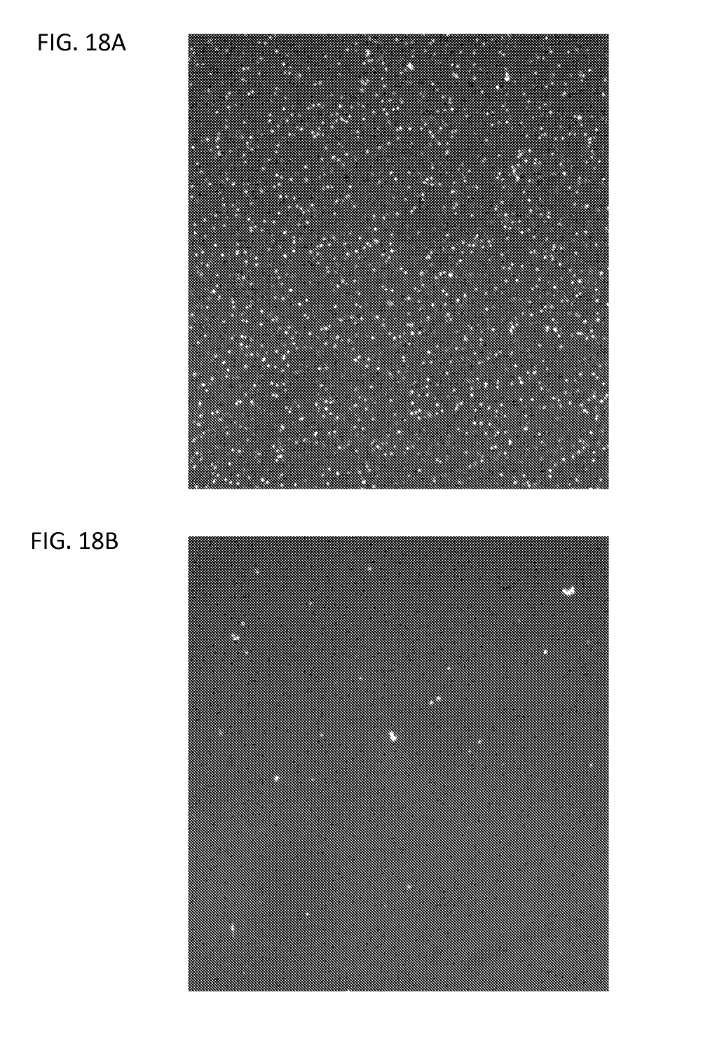

The outputs of the microfluidic device are shown in FIGS. 18A and 18B. The concentrated non-fat cells were collected substantially in the nucleated cell product fraction (FIG. 18A). The volume of the nucleated cell product fraction was reduced by a factor of about 8 compared with the input. Cells were then stained with acridine orange (2 mg/l) and imaged using a fluorescence microscope. The images show that fat cells are substantially absent in the product output of the microfluidic device, and that the non-fat nucleated cells are substantially collected in the nucleated cell fraction. The images also show that cells are in good morphology and that the product output is substantially free of broken cells. FIG. 18B shows the waste fraction of the microfluidic device output, containing few nucleated cells.

Cells isolated using the disclosed method and device were further characterized for total nucleated cell count and adherent viable nucleated cell count using an ADAM MC automated mammalian cell counter. The output of Chamber 4 had about 6.0×10⁵ total nucleated cells per ml of lipoaspirate processed. Alpha-MEM supplemented with 10% Fetal Bovine Serum (FBS) was used as the culture medium for adherent viable nucleated cell count. The output of Chamber 4 was sampled and cultured at 37 degrees Celsius for 3 days in the culture medium in cell culture chambers, for example, a cell culture dish or a cell culture flask. After 3 days, the culture medium was discarded and the cell culture chambers were washed using a Dulbecco phosphate buffered saline solution. Cells adhering to the culture chamber were then released from the chamber surface using Trypsin for 3 minutes. The adherent viable nucleated cell count was about 1.5×10⁵ per ml of lipoaspirate processed.

### Example 2

### A Method for Isolation of Non-Fat Cells from Human Lipoaspirate Tissues Using a Sample Processing Bag Device

Human lipoaspirate was processed using a sample processing bag device as depicted in FIG. 13. The device comprises a sample dissociation chamber (Chamber 1), a waste chamber (Chamber 2) and a cell refinement chamber (Chamber 3). The device is about 24 cm wide, about 36 cm long, and made of two polyvinyl chloride (PVC) sheets of about 0.3 mm thick each. The sample dissociation chamber and the cell refinement chamber comprise a first nylon mesh (Mesh 1) and a second nylon mesh (Mesh 2). The pore size of the first mesh is about 125 μm and the pore size of the second mesh is about 25 μm. The pore size of the first mesh may alternatively be between about 100 μm and about 160 μm, for example, about 100 μm, about 110 μm, about 120 μm, about 130 μm, about 140 μm, about 150 μm, or about 160 μm. The pore size of the second mesh may alternatively be between about 20 μm and about 50 μm, for example, about 20 μm, about 22 μm, about 25 μm, about 30 μm, about 35 μm, about 40 μm, or about 50 μm.

Human lipoaspirate was collected from a consented donor using tumescent liposuction and processed within 6 hours from collection. The sample was shipped and stored at 4 degrees Celsius before processing.

Initially, Stopcock 1 was set to a position that connects Chamber 1 and Chamber 2. A dissociation solution comprising 100 mg of collagenase, 100 mg of hyaluronidase, and 20,000 U of deoxyribonuclease was loaded into Syringe 2. The sample processing bag device was connected to a bag of rinsing solution comprising lactated Ringer's injection solution using the Spike.

About 75 ml of the lipoaspirate sample was injected into Chamber 1 from Port 1 using a syringe with a catheter tip.

A wash act was applied to clean the lipoaspirate sample. To begin a wash cycle, Stopcock 1 was set to a closed position to disconnect Chamber 1 fluidicly from chambers 2 and 3. About 100 ml of lactated Ringer's injection solution was injected into Chamber 1 using Syringe 1 and Stopcock 2 as a flow control device, which worked using the following sequence of acts: (a) switch Stopcock 2 to connect the rinsing solution to Syringe 1; (b) draw the rinsing solution into Syringe 1; (c) switch Stopcock 2 to connect Syringe 1 to Chamber 1; (d) inject the rinsing solution from Syringe 1 into Chamber 1. The sequence may be repeated until the desired volume of solutions is added to the dissociation chamber.

Chamber 1 was then massaged to mix the rinsing solution with the sample, and Stopcock 1 was switched to drain excess fluids, i.e. the waste solution, into Chamber 2. After draining, the first wash cycle was complete. The wash cycle was repeated twice.

The wash act may comprise one or many wash cycles, for example, one, two, three, four, or five cycles.

After washing, the dissociation solution was added to Chamber 1. About 100 ml of the rinsing solution was also added to Chamber 1. The sample processing bag device was then incubated at 37 degrees Celsius for an incubation time of about 60 minutes. Chamber 1 was massaged during this time to mix the sample with the dissociation solution. In some embodiments, other incubation times may also be used, for example, about 15 minutes, about 20 minutes, about 30 minutes, about 40 minutes, about 50 minutes, about 75 minutes, about 90 minutes, or about 120 minutes.

After incubation, individual cells released from the sample were passed through Stopcock 1 into Chamber 3, while large tissue debris were captured by Mesh 1 and left in Chamber 1. Mesh 2 in Chamber 3 further removed large adipocytes and debris from the dissociated sample. The non-fat cells, including pericytes, adipose derived stem cells and progenitor cells, were then collected at the Outlet Port of Chamber 3.

To concentrate the released cells and removed residual erythrocytes and debris, the released cells collected at the Outlet Port of Chamber 3 of the sample processing bag device were then run through a first microfluidic device disclosed in International Publication WO 2011/079217 A1. The microfluidic device comprised 73 modules arranged on a surface of a substrate. Each module comprised about 1,300 pillars configured into four rows. The microfluidic device comprised channels of substantially the same depth, between about 35 μm and about 50 μm. In another embodiment, the microfluidic device may comprise channels having a depth of between about 30 μm and about 80 μm, for example, about 30 μm, about 35 μm, about 40 μm, about 45 μm, about 50 μm, about 60 μm, about 70 μm, or about 80 μm. The cells at the output of the microfluidic device were concentrated by a factor of about 3. In another embodiment of the present invention, a microfluidic device may be used to concentrate the cells by a factor of greater than about 2.5, for example, by a factor of about 3, about 4, about 5, about 6, about 8, about 10, about 12, about 15, about 20, about 25, about 30, about 40, about 50, about 60, about 80, about 100, or about 125.

To remove enzymes, the cells were processed through a second microfluidic device disclosed in International Publication WO 2011/079217 A1. The second microfluidic device comprised 83 modules arranged on a surface of a substrate. Each module comprised about 900 pillars configured into four rows. A stream of the rinsing solution was introduced in each module and the cells were transferred into the rinsing solution stream, separated from the enzymes.

An enzyme-linked immunosorbent assay (ELISA) was applied to measure the residual amount of collagenase after the second microfluidic device. The result shows that the collagenase concentration was reduced by a factor of 1,000, and the refined cells contain less than 0.001 mg/ml of collagenase.

Having thus described several aspects of at least one embodiment, it is to be appreciated various alterations, modifications, combinations and improvements will readily occur to those skilled in the art. Such alterations, modifications, combinations and improvements are intended to be part of this disclosure, and are intended to be within the spirit and scope of the disclosure. Accordingly, the foregoing description and drawings are by way of example only.

What is claimed is:

1-35. (canceled)

36. An apparatus for processing biological samples, the apparatus comprising:
a first sheet of material;
a second sheet of a flexible material bonded to the first sheet of material;
a plurality of chambers defined between the first sheet of material and the second sheet of material, the plurality of chambers including:
a first chamber including an inlet configured to receive a fluid solution, a sample inlet configured to receive a biological sample, and an outlet,
a second chamber configured to receive waste fluid, the second chamber including an inlet in fluid communication with the outlet of the first chamber, and
a third chamber including an inlet in fluid communication with the first chamber and an outlet;
a first filtration mesh disposed between the inlet and the outlet of at least one of the first chamber and the third chamber; and
a first flow control device configured to control a flow of fluid between the first chamber and at least one of the second chamber and the third chamber.

37. The apparatus of claim 36, wherein the first filtration mesh comprises pores having pore sizes of between about 20 micrometers and about 50 micrometers.

38. The apparatus of claim 36, wherein the first filtration mesh is included in the third chamber, and wherein the first chamber includes a second filtration mesh having a pore size of between about 30 micrometers and about 1 millimeter, the first filtration mesh having a pore size smaller than the pore size of the second filtration mesh.

39. The apparatus of claim 36, wherein the first flow control device comprises a stopcock.

40. The apparatus of claim 36, being sterile and providing a substantially isolated environment to the biological sample.

41. The apparatus of claim 36, further comprising a second flow control device configured to control introduction of at least one of a rinsing solution and a dissociation solution into the first chamber.

42. The apparatus of claim 36, further comprising a downstream processing apparatus in fluid communication with the outlet of the third chamber and including at least one microfluidic device configured to separate a fluid output from the third chamber into a first solution having a first concentration of one or more cells of interest and a second solution having a second concentration of the one or more cells of interest which is less than the first concentration.

43. The apparatus of claim 36, wherein the sample inlet comprises a connector configured to receive a syringe.

44. A method of processing a sample in a tissue processing system, the method comprising:
providing a tissue processing device including:
a first sheet of material,
a second sheet of a flexible material bonded to the first sheet of material,
a plurality of chambers defined between the first sheet of material and the second sheet of material, the plurality of chambers including:
a first chamber including an inlet and an outlet;
a second chamber including an inlet in fluid communication with the outlet of the first chamber, and
a third chamber including an inlet in fluid communication with the first chamber and an outlet,
a first filtration mesh disposed between the inlet and the outlet of at least one of the first chamber and the third chamber, and
a flow control device in fluid communication with the first chamber, the second chamber and the third chamber;
introducing a sample to be processed into the first chamber through the inlet of the first chamber;
introducing a fluid solution to the first chamber of the tissue processing device;
washing the sample by mixing the fluid solution with the sample; and
draining a waste fluid from the first chamber to the second chamber.

45. The method of claim 44, further comprising retrieving the washed sample from the tissue processing device.

46. The method of claim 44, further comprising
introducing a dissociation solution to the first chamber;
mixing the dissociation solution with the sample in the first chamber;
incubating the sample for a period of time at a first temperature in the first chamber, incubating the sample releasing a population of cells of interest;
transferring the population of cells of interest to the third chamber;
passing the population of cells of interest through the first filtration mesh; and
harvesting the population of cells of interest from the outlet of the third chamber.

47. The method of claim 46, wherein the period of time is between about 5 minutes and about 30 hours.

48. The method of claim 46, wherein the period of time is between about 10 minutes and about 120 minutes.

49. The method of claim 46, wherein the first temperature is about 37 degrees Celsius.

50. The method of claim 46, wherein the dissociation solution comprises an enzyme.

51. The method of claim 50, wherein the dissociation solution comprises collagenase.

52. The method of claim 44, wherein the sample comprises an adipose tissue.

53. The method of claim 46, wherein the cells of interest comprise stem cells.

54. The method of claim 46, further comprising washing, concentrating, and reducing red blood cells from the population of cells of interest by passing the population of cells of interest through a microfluidic device.

55. The population of cells of interest of the method of claim 54.
